(19) United States
(12) Patent Application Publication
(10) Pub. No.: US 2026/0316900 A1
(43) Pub. Date: Oct. 15, 2026

(54) SEATING SYSTEM

(71) Applicant: Professional Components Ltd., Sidney (CA)

(72) Inventors: Lee ADAMS, Nanoose Bay (CA); Oliver WICKLUND, Victoria (CA)

(21) Appl. No.: 19/352,036

(22) Filed: Oct. 7, 2025

Related U.S. Application Data
(60) Provisional application No. 63/786,255, filed on Apr. 9, 2025.

(51) Int. Cl. B63B 29/04

(52) U.S. Cl. CPC B63B 29/04; B63B 2029/043

(57) ABSTRACT

A seating system for a vessel is described. The seating system includes a seat pan, a plate coupled thereto for support, a bracket anchored to the vessel, a joint assembly, a damper assembly, and an anti-friction device. The bracket can be vertically slidably relative to the vessel. The joint assembly couples the plate to the bracket to constrain the plate to reciprocal curvilinear motion relative to the bracket to allow confined horizontal movement of the seat pan relative to the bracket for shock mitigation. The damper assembly is oriented to dampen movement of the plate relative to the bracket to absorb shocks. The anti-friction device is disposed between the plate and the bracket to support the plate and the bracket against each other, independent of the joint assembly, while allowing the plate and the bracket to move relative to each other.

### TECHNICAL FIELD

The disclosure relates generally to seating systems, and more particularly to shock-mitigating seating systems.

### BACKGROUND

During operation of marine vessels, particularly during high-speed maneuvering or in stormy conditions, crew members operating the vessel face a significant challenge in remaining physically balanced and in control. Sudden and unexpected motions of the vessel can disorient crew members and lead to potential loss of control of the marine vessel and/or hamper performance. For example, an unexpected ocean swell taken in during high-speed operation can dislodge from seats. Such shocks are a menace to users, and successfully ameliorating them is an important goal.

Various seating system have been developed to improve operating crews' ability to deal with rough sea conditions, or other situations where crew members experience sudden, expected acceleration. Such seating systems typically comprise a substantially vertical shock attached to an underside of a relatively freely movably seat to allow the seat to rise and fall with the vessel while providing damping thereto so as to improve energy absorption.

In certain heavy-duty applications, such seating systems can undergo very high stresses, which could lead to failure. For example, a seat may shear under extreme stress. In such heavy-duty applications, shocks endured by the vessel can be multidirectional and hard to predict.

### SUMMARY

In some aspects, there is described a seating system for a vessel. The seating system also includes a seat pan; a plate coupled to the seat pan to support the seat pan, a bracket anchored to the vessel, a joint assembly coupling the plate to the bracket to constrain the plate to reciprocal curvilinear motion relative to the bracket to allow confined horizontal movement of the seat pan relative to the bracket for shock mitigation, a damper assembly oriented to dampen movement of the plate relative to the bracket to absorb horizontal shocks, and a plurality of rollers disposed between the plate and the bracket and spaced apart from the joint assembly to support the plate and the bracket against each other while allowing the plate and the bracket to move relative to each other.

Implementations may include one or more of the following features. The seating system where each of the plurality of rollers is attached to the bracket to self-rotate while anchored to the bracket. The plurality of rollers include a plurality of rotatable cylinders. The joint assembly may include a pair of cam slots and a pair of cam followers complementary to, and received into, the pair of cam slots. The plate defines a vertical face on which the cam slots are formed and to which the seat pan is attached. The joint assembly includes a pair of members, each of the members pivotably coupled to each of the plate and the bracket to allow the plate to swing about the bracket for shock mitigation. The damper assembly includes a pair of dampers corresponding to the pair of members. Each damper of the pair of dampers is attached to the bracket and is attached to a corresponding member of the pair of members via a corresponding arm extending perpendicularly away from the corresponding member. The joint assembly is configured to constrain the plate to planar motion relative to the bracket. All feasible kinematic configurations of the plate relative to the bracket define a centrode entirely traced vertically above the joint assembly and the seat pan. The damper assembly includes a pair of dampers inclined in opposing directions in a vertical plane to allow damping of horizontal movement of the plate relative to the bracket and vertical movement of the bracket relative to the vessel. The seating system may include: a base rigidly attached to the vessel, the bracket being slidably coupled to the base to allow constrained vertical sliding of the bracket relative to the base, the pair of dampers coupled to the base to allow damping of the constrained vertical sliding of the bracket relative to the base. A damper is connected to the base and the bracket to dampen vertical movement of the bracket relative to the base. The plate defines a vertical face to which is attached the seat pan, the seating system may include: a platform positioned below the seat pan and cantilevered perpendicularly outwardly from the plate to support the seat pan; and a brace disposed between the plate and the platform and inclined relative to the plate to couple the plate to the platform to support the platform. The seating system may include: an inclined damper coupled to the platform and the plate to dampen movement of the brace. The brace is a two-bar linkage. The plurality of rollers is a first plurality of rollers disposed below the joint assembly, the seating system may include: a second plurality of rollers disposed between the plate and the bracket and spaced apart from the joint assembly to support the plate and the bracket against each other while allowing the plate and the bracket to move relative to each other, the second plurality of rollers being positioned above the joint assembly. The vessel is the marine vessel.

In some aspects, there is described a suspension system for a seat pan of a vessel. The suspension system also includes a plate suitable to be coupled to the seat pan to support the seat pan; a bracket anchored suitable to be anchored to the vessel, a joint assembly coupling the plate to the bracket to constrain the plate to reciprocal curvilinear motion relative to the bracket to allow confined horizontal movement of the seat pan relative to the bracket for shock mitigation, a damper assembly oriented to dampen movement of the plate relative to the bracket to absorb horizontal shocks, and a plurality of rollers disposed between the plate and the bracket and spaced apart from the joint assembly to allow the plate and the bracket to roll against each other while supporting the plate against the bracket.

Implementations may include one or more of the following features. The suspension system where all feasible kinematic configurations of the plate relative to the bracket define a centrode entirely traced vertically above the joint assembly. A damper is connected to the base and the bracket to dampen vertical movement of the bracket relative to the base.

In some aspects, there is described a seating system for a vessel. The seating system also includes a seat pan; a plate coupled to the seat pan to support the seat pan; a base attached to the vessel; a bracket slidably coupled to the base to allow constrained vertical sliding of the bracket relative to the base; a joint assembly coupling the plate to the bracket to constrain the plate to reciprocal curvilinear motion relative to the bracket to allow confined horizontal movement of the seat pan relative to the bracket for shock mitigation; and a damper assembly oriented to dampen movement of the plate relative to the bracket to absorb horizontal shocks, and connected to the base and the bracket to dampen vertical movement of the bracket relative to the base.

Implementations may include one or more of the following features. The seating system where the base defines a pair of guides opposite to each other to receive the bracket between the pair of guides, the bracket being received in the pair of guides to constrain the bracket to vertical motion between the pair of guides. The bracket includes a pair of wheels movably engaged with the pair of guides, each of the pair of guides including a track suitable to receive a corresponding wheel of the pair of wheels to allow rolling of the pair of wheels in the pair of guides to facilitate vertical movement of the bracket. The joint assembly is coupled to the plate via a vertical face of the plate that defines a vertical plane, the plate being constrained to planar motion relative to the bracket parallel to the vertical plane, the bracket being constrained to vertical motion parallel to the vertical plane. The joint assembly may include a pair of cam slots and a pair of cam followers complementary to, and received into, the pair of cam slots. The plate defines a vertical face on which the cam slots are formed and to which the seat pan is attached. The joint assembly includes a pair of members, each of the members pivotably coupled to each of the plate and the bracket to allow the plate to swing about the bracket for shock mitigation. The damper assembly includes a pair of dampers corresponding to the pair of members. Each damper of the pair of dampers is attached to the bracket and is coupled to a corresponding member of the pair of members via a corresponding arm extending perpendicularly away from the corresponding member. The joint assembly is configured to constrain the plate to horizontal and vertical motion within a vertical plane relative to the bracket. All feasible kinematic configurations of the plate relative to the bracket define a centrode entirely traced vertically above the joint assembly and the seat pan. The damper assembly includes a pair of dampers inclined in opposing directions in a vertical plane to allow damping of horizontal and vertical movement of the bracket relative to the base. The plate defines a vertical face to which is attached the seat pan. The seating system may include: a platform positioned below the seat pan and cantilevered perpendicularly outwardly from the plate to support the seat pan; and a brace disposed between the plate and the platform and inclined relative to the plate to couple the plate to the platform to support the platform. The seating system may include: a seat pan damper coupled to the platform and the plate to dampen movement of the brace. The brace is a two-bar linkage. The seating system may include: a plurality of rollers disposed between the plate and the bracket and spaced apart from the joint assembly to support the plate and the bracket against each other while allowing the plate and the bracket to move relative to each other. Each of the plurality of rollers is attached to the bracket to self-rotate while anchored to the bracket. The plurality of rollers are rotatable cylinders. The plurality of rollers are a first plurality of rollers and are disposed below the joint assembly, the seating system may include: a second plurality of rollers disposed between the plate and the bracket and spaced apart from the joint assembly to support the plate and the bracket against each other while allowing the plate and the bracket to move relative to each other, the second plurality of rollers being positioned above the joint assembly. The vessel is the user vessel.

In some aspects, there is described a suspension system for a seat pan of a vessel. The suspension system also includes a plate suitable to be coupled to the seat pan to support the seat pan; a base suitable to be attached to the vessel; a bracket slidably coupled to the base to allow constrained vertical sliding of the bracket relative to the base; a joint assembly coupling the plate to the bracket to constrain the plate to cyclic planar motion relative to the bracket to allow confined horizontal movement of the seat pan relative to the bracket for shock mitigation; and a damper assembly oriented to dampen movement of the plate relative to the bracket to absorb horizontal shocks, and connected to the base and the bracket to dampen vertical movement of the bracket relative to the base.

In some aspects, there is described a seating system for a vessel. The seating system also includes a seat pan; a plate coupled to the seat pan to support the seat pan, a bracket anchored to the vessel, a joint assembly coupling the plate to the bracket to constrain the plate to reciprocal curvilinear motion relative to the bracket to allow confined horizontal movement of the seat pan relative to the bracket for shock mitigation, a damper assembly oriented to dampen movement of the plate relative to the bracket to absorb horizontal shocks, and an anti-friction device disposed between the plate and the bracket to support the plate and the bracket against each other, independent of the joint assembly, while allowing the plate and the bracket to move relative to each other.

Implementations may include one or more of the following features. The seating system where the anti-friction device includes a plurality of rollers. The anti-friction device is spaced apart from the joint assembly. Each of the plurality of rollers is attached to the bracket to self-rotate while anchored to the bracket. The plurality of rollers include a plurality of rotatable cylinders. The joint assembly may include a pair of cam slots and a pair of cam followers complementary to, and received into, the pair of cam slots. The plate defines a vertical face on which the cam slots are formed and to which the seat pan is attached. The joint assembly includes a pair of members, each of the members pivotably coupled to each of the plate and the bracket to allow the plate to swing about the bracket for shock mitigation. The damper assembly includes a pair of dampers corresponding to the pair of members. Each damper of the pair of dampers is attached to the bracket and is attached to a corresponding member of the pair of members via a corresponding arm extending perpendicularly away from the corresponding member. The joint assembly is configured to constrain the plate to planar motion relative to the bracket. All feasible kinematic configurations of the plate relative to the bracket define a centrode entirely traced vertically above the joint assembly and the seat pan. The damper assembly includes a pair of dampers inclined in opposing directions in a vertical plane to allow damping of horizontal movement of the plate relative to the bracket and vertical movement of the bracket relative to the vessel. The seating system may include: a base rigidly attached to the vessel, the bracket being slidably coupled to the base to allow constrained vertical sliding of the bracket relative to the base, the pair of dampers coupled to the base to allow damping of the constrained vertical sliding of the bracket relative to the base. A damper is connected to the base and the bracket to dampen vertical movement of the bracket relative to the base. The plate defines a vertical face to which is attached the seat pan, the seating system may include: a platform positioned below the seat pan and cantilevered perpendicularly outwardly from the plate to support the seat pan; and a brace disposed between the plate and the platform and inclined relative to the plate to couple the plate to the platform to support the platform. The seating system may include: an inclined damper coupled to the platform and the plate to dampen movement of the brace. The brace is a two-bar linkage. The anti-friction device is a first anti-friction device and is disposed below the joint assembly, the seating system may include: a second anti-friction device disposed between the plate and the bracket to support the plate and the bracket against each other, independent of the joint assembly, while allowing the plate and the bracket to move relative to each other, the second anti-friction device being positioned above the joint assembly. The second anti-friction device is spaced apart from the joint assembly. The vessel is the marine vessel.

In some aspects, there is described a suspension system for a seat pan of a vessel. The suspension system also includes a plate suitable to be coupled to the seat pan to support the seat pan; a bracket anchored suitable to be anchored to the vessel, a joint assembly coupling the plate to the bracket to constrain the plate to reciprocal curvilinear motion relative to the bracket to allow confined horizontal movement of the seat pan relative to the bracket for shock mitigation, a damper assembly oriented to dampen movement of the plate relative to the bracket to absorb horizontal shocks, and an anti-friction device disposed between the plate and the bracket to support the plate and the bracket against each other, independent of the joint assembly, while allowing the plate and the bracket to move relative to each other.

Implementations may include one or more of the following features. The suspension system where all feasible kinematic configurations of the plate relative to the bracket define a centrode entirely traced vertically above the joint assembly. A damper is connected to the base and the bracket to dampen vertical movement of the bracket relative to the base.

In some aspects, there is described a seating system for a vessel. The seating system also includes a seat pan; a plate coupled to the seat pan to support the seat pan; a bracket slidably coupled to the vessel to allow constrained vertical sliding of the bracket relative to the vessel; a joint assembly coupling the plate to the bracket to constrain the plate to reciprocal curvilinear motion relative to the bracket to allow confined horizontal movement of the seat pan relative to the bracket for shock mitigation; and a damper assembly oriented to dampen movement of the plate relative to the bracket to absorb horizontal shocks, and connected to the vessel and the bracket to dampen vertical movement of the bracket relative to the vessel.

Implementations may include one or more of the following features. The seating system further comprises a base attached to the vessel and defining a pair of guides opposite to each other to receive the bracket between the pair of guides to slidably couple the bracket to the base to allow constrained vertical sliding of the bracket relative to the base, the bracket being received in the pair of guides to constrain the bracket to vertical motion between the pair of guides, the damper assembly connected to the base and the bracket to dampen vertical movement of the bracket relative to the base. The bracket includes a pair of wheels movably engaged with the pair of guides, each of the pair of guides including a track suitable to receive a corresponding wheel of the pair of wheels to allow rolling of the pair of wheels in the pair of guides to facilitate vertical movement of the bracket. The joint assembly is coupled to the plate via a vertical face of the plate that defines a vertical plane, the plate being constrained to planar motion relative to the bracket parallel to the vertical plane, the bracket being constrained to vertical motion parallel to the vertical plane. The joint assembly may include a pair of cam slots and a pair of cam followers complementary to, and received into, the pair of cam slots. The plate defines a vertical face on which the cam slots are formed and to which the seat pan is attached. The joint assembly includes a pair of members, each of the members pivotably coupled to each of the plate and the bracket to allow the plate to swing about the bracket for shock mitigation. The damper assembly includes a pair of dampers corresponding to the pair of members. Each damper of the pair of dampers is attached to the bracket and is coupled to a corresponding member of the pair of members via a corresponding arm extending perpendicularly away from the corresponding member. The joint assembly is configured to constrain the plate to horizontal and vertical motion within a vertical plane relative to the bracket. All feasible kinematic configurations of the plate relative to the bracket define a centrode entirely traced vertically above the joint assembly and the seat pan. The damper assembly includes a pair of dampers inclined in opposing directions in a vertical plane to allow damping of horizontal and vertical movement of the bracket relative to the vessel. The plate defines a vertical face to which is attached the seat pan. The seating system may include: a platform positioned below the seat pan and cantilevered perpendicularly outwardly from the plate to support the seat pan; and a brace disposed between the plate and the platform and inclined relative to the plate to couple the plate to the platform to support the platform. The seating system may include: a seat pan damper coupled to the platform and the plate to dampen movement of the brace. The brace is a two-bar linkage. The seating system may include: an anti-friction device disposed between the plate and the bracket to support the plate and the bracket against each other, independent of the joint assembly (and/or spaced apart from the joint assembly), while allowing the plate and the bracket to move relative to each other. The anti-friction device includes a plurality of rollers. Each of the plurality of rollers is attached to the bracket to self-rotate while anchored to the bracket. The plurality of rollers are rotatable cylinders. The anti-friction device is a first anti-friction device and is disposed below the joint assembly, the seating system may include: a second anti-friction disposed between the plate and the bracket to support the plate and the bracket against each other, independent of the joint assembly (and/or spaced apart from the joint assembly), while allowing the plate and the bracket to move relative to each other, the second anti-friction device being positioned above the joint assembly. The vessel is the user vessel.

In some aspects, there is described a suspension system for a seat pan of a vessel. The suspension system also includes a plate suitable to be coupled to the seat pan to support the seat pan; a bracket slidably coupled to the vessel to allow constrained vertical sliding of the bracket relative to the vessel; a joint assembly coupling the plate to the bracket to constrain the plate to cyclic planar motion relative to the bracket to allow confined horizontal movement of the seat pan relative to the bracket for shock mitigation; and a damper assembly oriented to dampen movement of the plate relative to the bracket to absorb horizontal shocks, and connected to the vessel and the bracket to dampen vertical movement of the bracket relative to the vessel.

Embodiments can include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a schematic view of an example vessel during field operation thereof;

FIG. 2A is a perspective view of the seating system, in accordance with an embodiment;

FIG. 2B is a rear elevation view of the seating system of FIG. 2A;

FIG. 2C is a front elevation view of the seating system of FIG. 2A;

FIG. 2D is a side elevation view of the seating system of FIG. 2A;

FIG. 3A is a perspective view of a suspension system, in accordance with an embodiment;

FIG. 3B is a partially exploded perspective view of the suspension system of FIG. 3A;

FIG. 4A is a perspective view of a subassembly of the suspension system of FIGS. 3A-3B;

FIG. 4B is a front elevation view of the subassembly of FIG. 4A;

FIG. 4C is a rear elevation view of the subassembly of FIG. 4A;

FIG. 4D is a side elevation view of the subassembly of FIG. 4A;

FIG. 4E is a bottom plan view of the subassembly of FIG. 4A;

FIG. 4F is a top plan view of the subassembly of FIG. 4A;

FIG. 5A is a perspective view of a subassembly of the suspension system, in accordance with another embodiment;

FIG. 5B is a front elevation view of the subassembly of FIG. 5A;

FIG. 5C is a side elevation view of the subassembly of FIG. 5A;

FIG. 6A is a perspective view of a subassembly of the suspension system, in accordance with yet another embodiment;

FIG. 6B is a front elevation view of the subassembly of FIG. 6A;

FIG. 6C is a side elevation view of the subassembly of FIG. 6A;

FIG. 7A is a perspective view of a suspension system, in accordance with another embodiment;

FIG. 7B is a partially exploded perspective view of the suspension system of FIG. 7A;

FIG. 7C is a perspective view of the suspension system of FIG. 7A having mounted thereon a seat pan;

FIG. 8A is a schematic front elevation view of a portion of a suspension system in a first stage of operation, in accordance with an embodiment;

FIG. 8B is a schematic front elevation view of the portion of the suspension system in a second stage of operation, in accordance with an embodiment;

FIG. 8C is a schematic front elevation view of the portion of the suspension system in a third stage of operation, in accordance with an embodiment;

FIG. 8D is an enlarged front elevation view of the portion of the suspension system in FIGS. 8A-8C;

FIG. 9 is a schematic front elevation view of a subassembly, in accordance with another embodiment;

FIG. 10 is a schematic front elevation view of a subassembly, in accordance with yet another embodiment;

FIG. 11 is a schematic front elevation view of a subassembly, in accordance with a further embodiment;

FIG. 12 is a schematic front elevation view of a subassembly, in accordance with yet further embodiment;

FIG. 13 is a front elevation of a suspension system, in accordance with another embodiment;

FIG. 14 is a schematic front elevation view of a suspension system, in accordance with yet another embodiment;

FIG. 15 is a schematic front elevation view of a suspension system, in accordance with a further embodiment;

FIG. 16 is a perspective view of a seating system, in accordance with an embodiment;

FIG. 17A is a front elevation view of a subassembly of the seating system of FIG. 16 in a first position;

FIG. 17B is a front elevation view of a subassembly of the seating system of FIG. 16 in a second position; and

FIG. 17C is a front elevation view of a subassembly of the seating system of FIG. 16 in a third position.

### DETAILED DESCRIPTION

The following disclosure relates to a seating system for a marine vessel. In some embodiments, the systems and suspensions thereof described herein provide improved damping of multidimensional shocks in an advantageously compact package with improved rigidity and strength. As referred to herein, the term vessel may include various types of craft and vehicles, including boats, aircraft, trucks, spacecraft, armoured personal carrier, and various other vehicles for use on land, air, sea, and/or space. Nevertheless, it is understood that the systems and devices disclosed herein are particularly suited to marine vessels.

The seating system comprises a plate coupled to a seat pan to support the seat pan and a joint assembly coupling the plate to a bracket anchored to the vessel to constrain the plate to reciprocal motion or reciprocal curvilinear motion, relative to the bracket to allow confined horizontal movement of the seat pan relative to the bracket for shock mitigation. A damper assembly is oriented to dampen movement of the plate relative to the bracket to absorb horizontal shocks. A plurality of rollers are disposed between the plate and the bracket and spaced apart from the joint assembly to support the plate and the bracket against each other while allowing the plate and the bracket to move relative to each other. The bracket can be slidably coupled to a base attached to the vessel to allow vertical movement of the seat pan, and the damper assembly may also be configured to dampen vertical movement of the seat pan.

Advantageously, the plurality of rollers provide rigidity to the assembly to allow achieving a compact assembly at a lower cost. For example, the seat pan may be supported by a plate that is pivotably coupled to the bracket without any further coupling connections or attachments to the bracket. For example, the plurality of rollers may be strategically positioned between the plate and the bracket to achieve a desired rigidity. It is found particularly advantageous to use two spaced-apart pairs of rollers (see FIG. 9), as it allows the use of longer linkages and members in the assembly, as will be described later.

Advantageously, the seating system can mitigate shocks, by absorbing or dissipating them, in multiple directions and particularly in both vertical and horizontal directions in a compact package.

Aspects of various embodiments are described in relation to the figures.

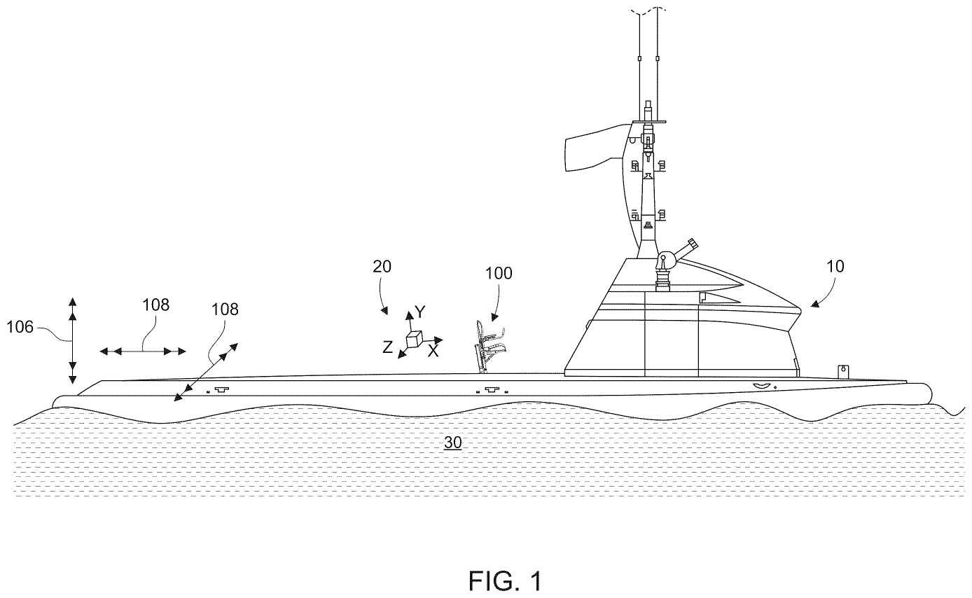

FIG. 1 is a schematic view of an example vessel 10 during field operation thereof. As shown in FIG. 1, the vessel 10 may be a marine vessel at sea 30.

The vessel 10 undergoes multidirectional motion, e.g. due to sea conditions, self-propulsion, and other factors. As illustrated by the double-headed arrows in FIG. 1, the vessel may undergo vertical movement 106 and horizontal movement 108 in a non-vertical plane.

The vessel 10 comprises, or has mounted thereon, a seating system 100. The seating system 100 may be suitable for seating an operator of the vessel 10. For example, in various embodiments, the seating system 100 may include controls to control the vessel 10.

The seating system 100 may generally define three mutually non-parallel directions 20. The directions 20 include a vertical direction (axis Y) and horizontal directions (axis X and axis Z) that are non-parallel to the vertical direction, e.g. perpendicular thereto. The horizontal directions may also be referred to as lateral directions. As referred to herein, a vertical direction may refer to a direction of the three directions 20 that is most aligned with the direction of gravitational acceleration.

In many cases, vertical movements 106 and the horizontal movements 108 may take the form of shocks, e.g. sudden, unexpected, and/or large motions, or motions wherein the rate of acceleration (jerk) may be excessive. In such circumstances, a person seated on the seating system 100 (a seat user or user), e.g. an operator of the vessel 10, may be knocked off the seating system 100, may become disoriented, and/or experience discomfort especially in maintaining a command position on the seating system 100. Such difficulties may negatively impact performance of an operator seated in the seating system 100 (or seat) and may lead to unsafe situations on-board the vessel 10. Accordingly, the seating system 100 is configured to mitigate such shocks to improve user experience and/or improve performance.

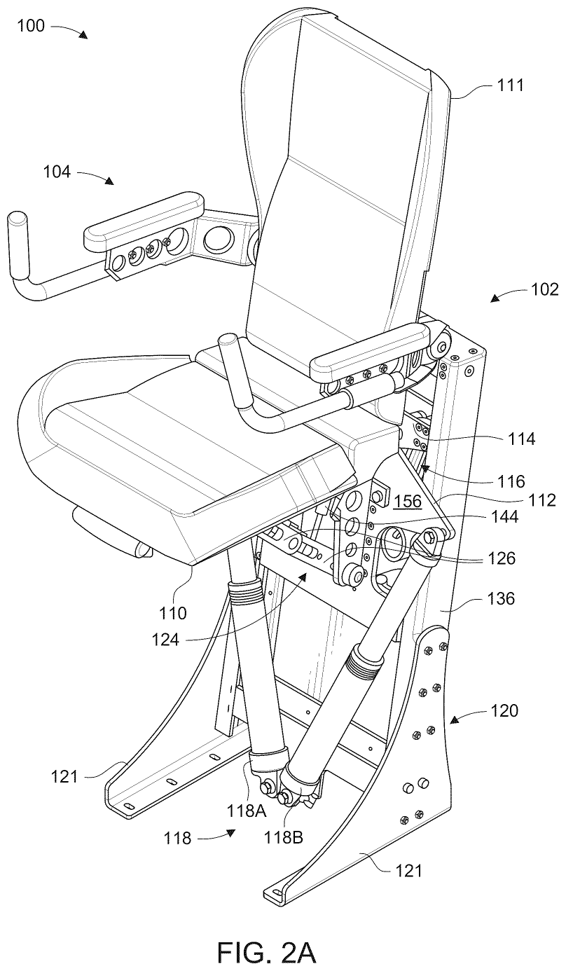

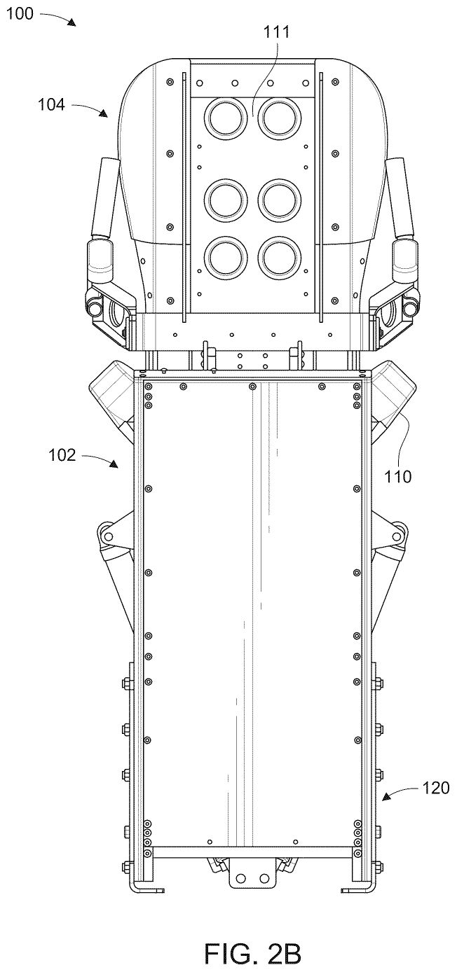

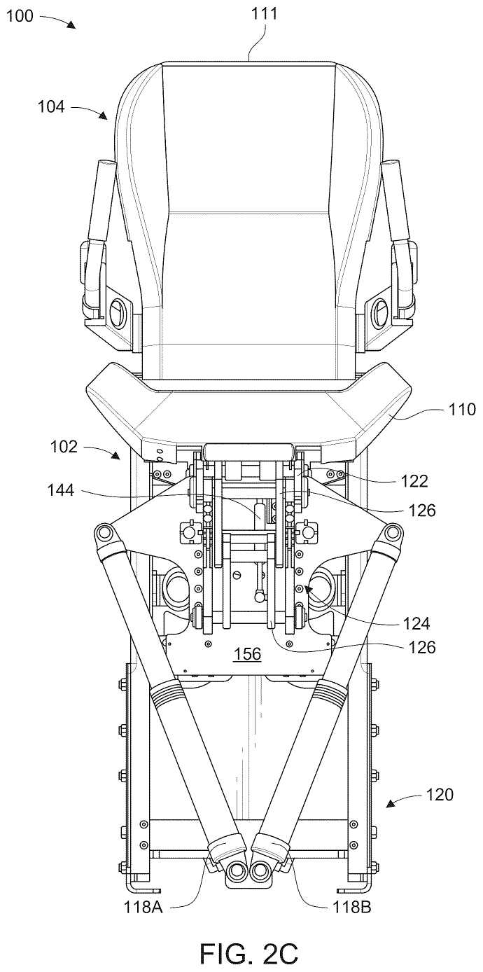

FIG. 2A is a perspective view of the seating system 100, in accordance with an embodiment.

FIG. 2B is a rear elevation view of the seating system 100 of FIG. 2A.

FIG. 2C is a front elevation view of the seating system 100 of FIG. 2A.

FIG. 2D is a side elevation view of the seating system 100 of FIG. 2A.

The seating system 100 comprises a suspension system 102 and a seat 104.

Referring to FIGS. 2A-2C, the seat 104 includes a seat pan 110 and a back rest 111. Cushions, arm rests, hand holds, and/or other components may be provided on the seat 104. In various embodiments, a user may sit on the seat pan 110. In some embodiments, the seat pan 110 or a central sitting area of the seat pan 110 may define the horizontal direction.

The suspension system 102 system supports the seat 104 and provides damping of motion of the seat 104, e.g. as the vessel 10 is in motion. Such damping may be provided in vertical and/or horizontal directions. It is understood that the horizontal and vertical directions, as referred to herein, are defined by the suspension system 102. The vertical direction may define a component in the direction of gravitational acceleration that is greater than components of the horizontal directions. The vertical direction may be defined by the seat pan since the seat pan is configured to support a user against gravity. In some embodiments, the suspension system 102 system may provide only damping in the horizontal direction. In this case, the horizontal direction may be defined as a direction whose greatest component is not aligned with the direction of gravitational acceleration.

The suspension system 102 includes a base 120 attached to the vessel 10. The base 120 may be rigidly attached to the vessel 10. The base 120 may be attached to the vessel 10 via a pair of legs 121. For example, the legs 121 may be bolted down to the vessel 10.

The suspension system 102 includes a plate 112 coupled to the seat pan 110 to support the seat pan 110, and a bracket 114 suitable to be anchored to the vessel 10. For example, the bracket 114 may be bolted down, directly or indirectly, to the vessel 10, or movably coupled to a component of the suspension system 102 that is bolted down to the vessel 10.

The plate 112 may define a face 156. The face 156 may be a vertical face. The seat pan 110 may be attached to the face 156 to attach the seat pan 110 to the plate 112.

A platform 122 may be attached to the plate 112 and the seat pan 110. The platform 122 may be positioned below the seat pan 110. The platform 122 may be cantilevered perpendicularly outwardly from the plate 112 to support the seat pan 110.

A brace 124 may be disposed between the plate 112 and the platform 122. The brace 124 is inclined relative to the plate 112 to couple the plate 112 to the platform 122 to support the platform 122. In various embodiments, the brace 124 is a two-bar linkage. As shown in FIGS. 2C-2D, the brace 124 may comprise a pair of bars 126 that are pivotably coupled to each other to form a two-bar linkage. An inclined seat pan damper 144 may be coupled to the platform 122 and the plate 112 to dampen movement of the brace 124 and/or to provide and adjustable seat for a user.

Advantageously, the two-bar linkage may facilitate movement and damping of shocks to the seat pan 110. In some embodiments, the two-bar linkage may be replaced with a rigid single-bar linkage.

A joint assembly 116 couples the plate 112 to the bracket 114 to constrain motion of the plate 112 to allow confined horizontal movement of the seat pan 110 relative to the bracket 114 for shock mitigation.

For example, when the seating system 100 is subject to an external at least partially horizontal shock, e.g. caused due to a movement of the vessel 10 along a direction at least partially parallel to the X-Z plane, the joint assembly 116 allows the seat pan 110 to move horizontally to at least partially avoid (sudden) or delay transfer of the horizontal shock to a user seated on the seat pan 110. Such horizontal movement is confined (relative to the bracket 114) based on a kinematically predetermined path of the seat pan 110 relative to the bracket 114, e.g. as defined based movement of the seat pan 110 when it is unloaded and subject to horizontal forces. Confined motion refers to motion that is limited in extent.

The joint assembly 116 may be configured to couple the plate 112 to the bracket 114 to constrain the plate 112 to reciprocal motion or reciprocal curvilinear motion relative to the bracket 114. For example, the plate 112 may be configured to rock back-and-forth along a predetermined path. The joint assembly 116 may be configured to couple the plate 112 to the bracket 114 to constrain the plate 112 to reciprocal curvilinear motion relative to the bracket 114. As referred to herein, reciprocal curvilinear motion refers to back-and-forth repetitive motion along predetermined a linear or a curved path. In some cases, the reciprocal curvilinear motion may be planar motion. For example, the plate 112 may rotate about an instant center located above the seat 104 or seat pan 110 (or any other point above the joint assembly 116) between two predetermined end points defining a sector of a circle centered at the instant center, e.g. the plate 112 may rotate back and forth; alternating between clockwise and counter-clockwise rotation about the instant center.

In various embodiments, the joint assembly 116 may be configured to constrain the plate 112 to planar motion relative to the bracket 114, e.g. partly circular motion in a plane.

In some embodiments, the plate 112 may not be constrained to pure rotation about a unitary instant center relative to the bracket 114. For example, the plate 112 may move relative to the bracket 114 so as to define an instant centre having a varying location throughout movement of the plate 112 (relative to the bracket 114). The path traced by the instant center, whether unitary (fixed instant center) or varying (moving instant center), may be referred to as a centrode associated with the movement. Advantageously, having an instant centre (or centrode) that is always (vertically) above the seat 104 or seat pan 110 may improve stability of the seating system 100 since the seat pan 110 would then tend to return to a position defined by the lowest gravitational potential that is dynamically stable. As such, in some embodiments, all feasible kinematic configurations of the plate 112 relative to the bracket define a centrode entirely traced vertically above the joint assembly.

Referring to FIG. 2D, the joint assembly 116 may be configured to constrain the plate 112 to horizontal and vertical motion within a vertical plane 142, i.e. motions in and out of the vertical plane 142 may be precluded from a range of possible achievable kinematic configurations of the plate 112 when coupled to the bracket 114 via the joint assembly 116. The vertical plane 142 may be defined by the joint assembly 116 and/or the plate 112. In some embodiments, the vertical plane 142 may be defined by the face 156 of the plate 112. In some embodiments, the face 156 may be coincident with the vertical plane 142 or parallel thereto.

In various embodiments, the joint assembly 116 may be configured to constrain the plate 112 to cyclic, or cyclic planar, motion relative to the bracket 114.

The motion of the plate 112 relative to the bracket 114 described above may allow confined horizontal movement of the seat pan 110 relative to the bracket 114. Such movement may facilitate shock mitigation, e.g. by providing additional damping of the movement of the seat pan 110, and mitigate a risk of a user being displaced away from the seating system 100 due to a lateral movement of the vessel 10 or other non-vertical shock. As referred to herein, confined horizontal movement may refer to horizontal movement that is confined between predetermined limits, e.g. the joint assembly 116 may contain stops to mitigate unbounded or uncontrolled horizontal movement of the seat pan 110 and/or the remainder of the seat 104.

As referred to herein, the motion or path of the plate 112 may refer to a path traced by a point on the plate 112 as the plate 112 moves. Paths traced by any number of points on the plate 112 may be substantially parallel as the eccentricity in paths caused by deformation of the plate 112 may be small in comparison to the length of the paths themselves.

The suspension system 102 includes a damper assembly 118 oriented to dampen movement of the plate 112 relative to the bracket 114 to absorb horizontal shocks. Referring to FIGS. 2A-2D, the damper assembly 118 may include a pair of dampers 118A, 118B.

The pair of dampers 118A, 118B may be attached to the bracket 114. For example, the pair of dampers 118A, 118B may be attached to the bracket 114 via the base 120. In some embodiments, the pair of dampers 118A, 118B are rigidly attached to the bracket 114. In some embodiments, the bracket 114 may yet slide relative to the pair of dampers 118A, 118B, e.g. when the pair of dampers 118A, 118B are rigidly attached to the base 120 and the bracket 114 is slidably coupled to the base 120.

Referring to FIGS. 2A-2D, the pair of dampers 118A, 118B of the damper assembly 118 are inclined in opposing directions within a plane parallel to the vertical plane 142. Such positioning and orientation of the pair of damper 118A, 118B may allow damping of horizontal movement of the plate 112 relative to the bracket 114. Due to the orientation of the pair of dampers 118A, 118B, a certain amount of damping may also be possible in the vertical direction via the pair of dampers 118A, 118B. In various embodiments, the bracket 114 is configured for movement relative to the vessel 10. For example, the bracket 114 may be configured or be allowed to slide or otherwise move vertically relative to the vessel 10. In such cases, the pair of dampers 118A, 118B may allows damping of vertical movement of the bracket 114 relative to the vessel. In various embodiments, the pair of dampers 118A, 118B are inclined in opposing directions in the vertical plane 142 to allow damping of horizontal and vertical movement of the bracket 114 relative to the base 120.

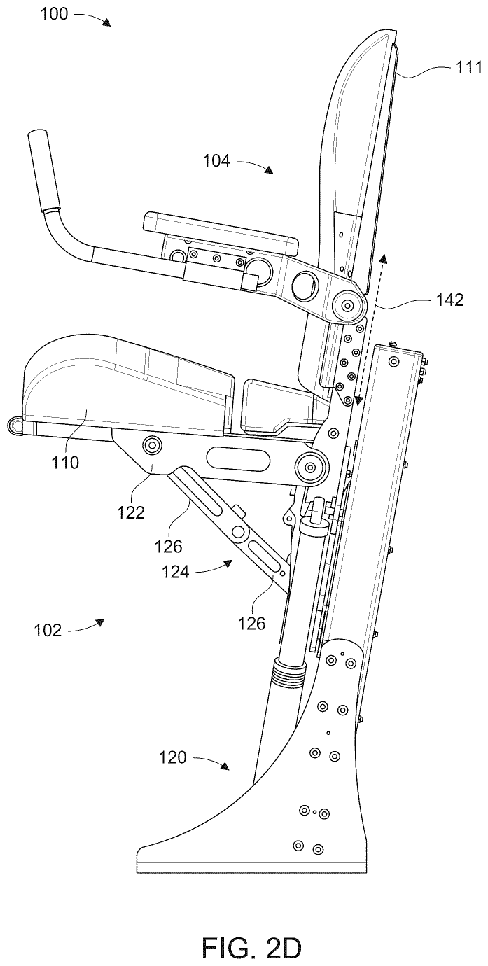

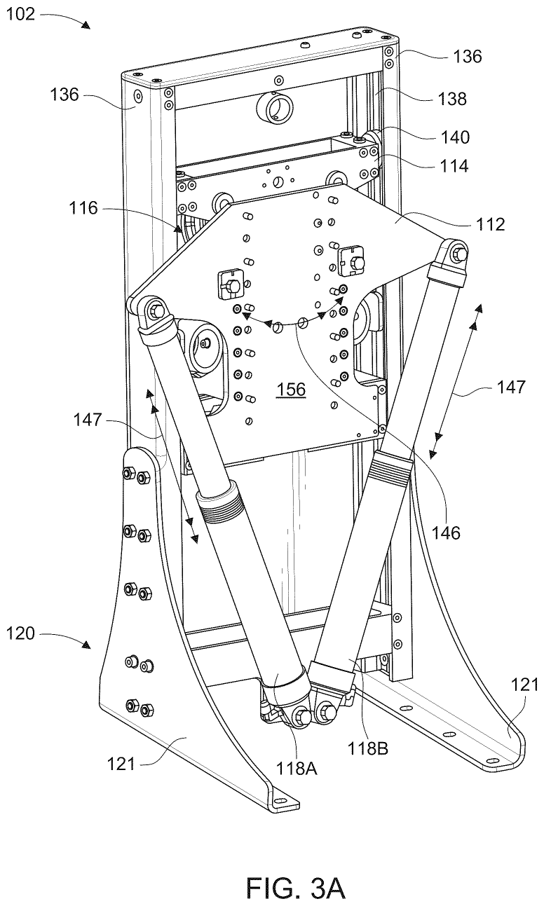

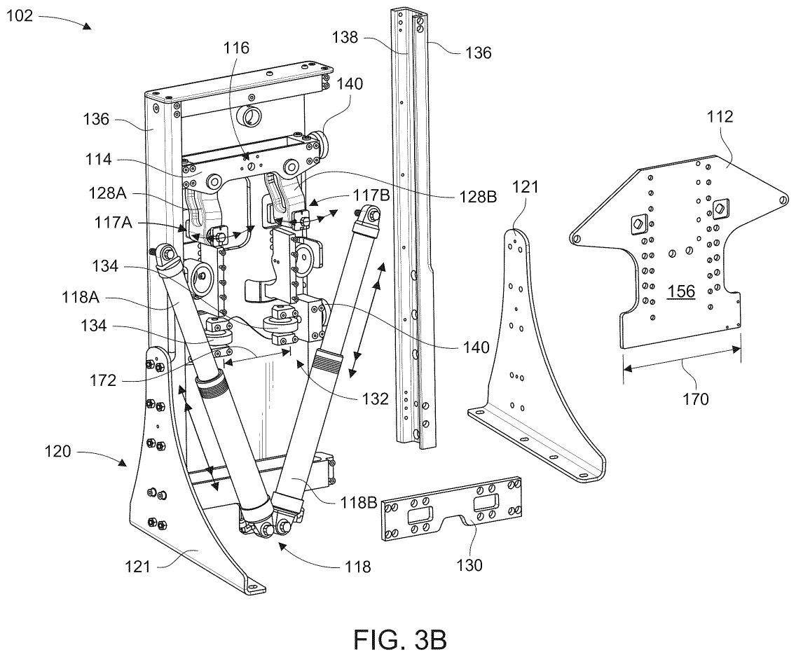

FIG. 3A is a perspective view of a suspension system 102, in accordance with an embodiment.

FIG. 3B is a partially exploded perspective view of the suspension system 102 of FIG. 3A.

Referring to FIGS. 3A-3B, the bracket 114 is slidably coupled to the base 120 to allow constrained vertical sliding of the bracket 114 relative to the base 120. As such, the plate 112 may be allowed to move vertically so as to support vertical movement of the seat pan 110.

As shown in FIGS. 3A-3B, the base 120 defines a pair of guides 136. The pair of guides 136 are disposed opposite to each other to receive the bracket 114 between the pair of guides 136. The bracket 114 when so received in the pair of guides 136 is constrained by the pair of guides 136 to motion between and along the pair of guides 136. The pair of guides 136 may be vertically aligned so that such motion is vertical motion.

In various embodiments, the bracket 114 includes wheels 140 movably engaged with the pair of guides 136. For example, the wheels 140 may be no more than a pair of wheels, each associated with a corresponding guide of the pair of guides 136. As shown in FIGS. 3A-3B, the wheels 140 may be at least two pairs of wheels, each wheel of which being positioned at a corner of the bracket 114. Each guide of the pair of guides 136 may include a track 138 suitable to receive a corresponding wheel 140 to allow rolling of the wheel 140 in guide 136 to facilitate vertical movement of the bracket 114. As such, the wheels 140 may be received in the pair of guides 136 to allow rolling of the pair of wheels 140 in the pair of guides 136 to facilitate vertical movement of the bracket 114. The dampers 118A, 118B are coupled or connected to the base 120 to allow damping of the constrained vertical sliding of the bracket 114 relative to the base 120. In various embodiments, the guides 136 may define stops to limit vertical travel of the bracket 114.

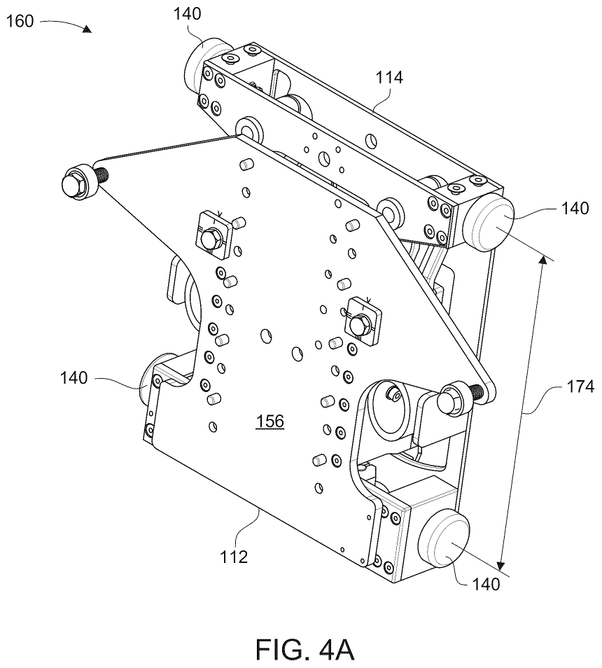

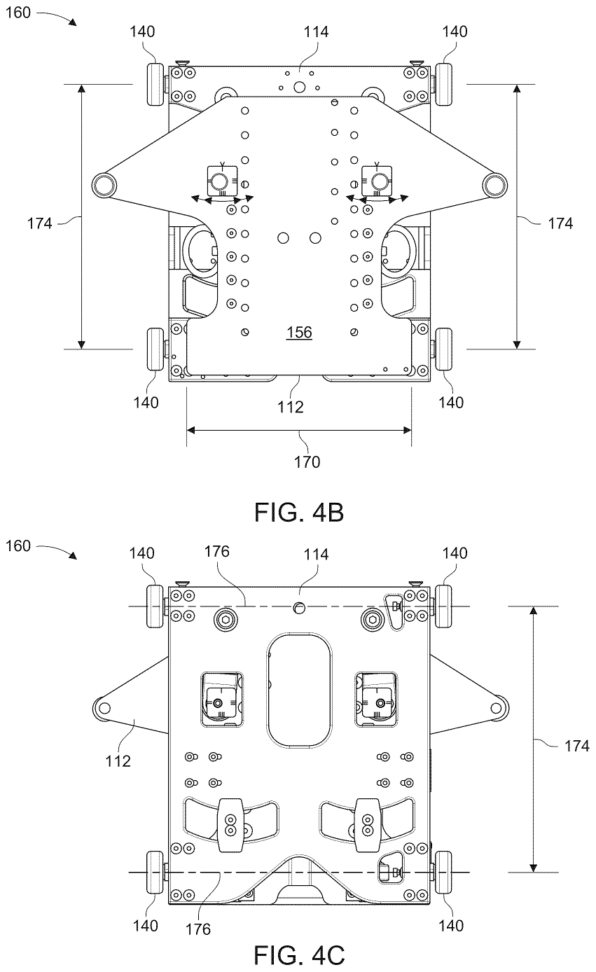

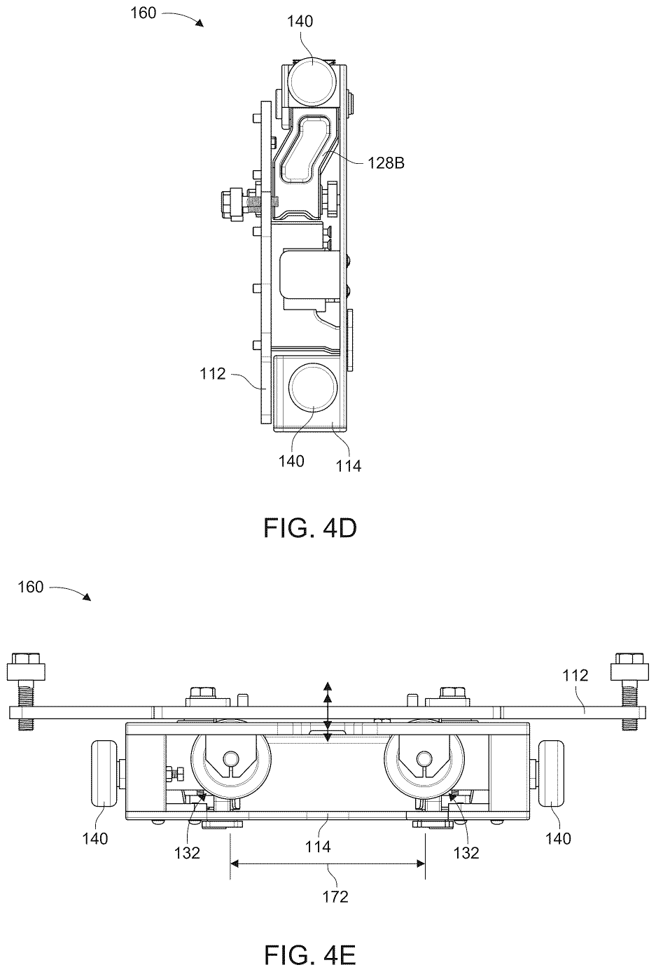

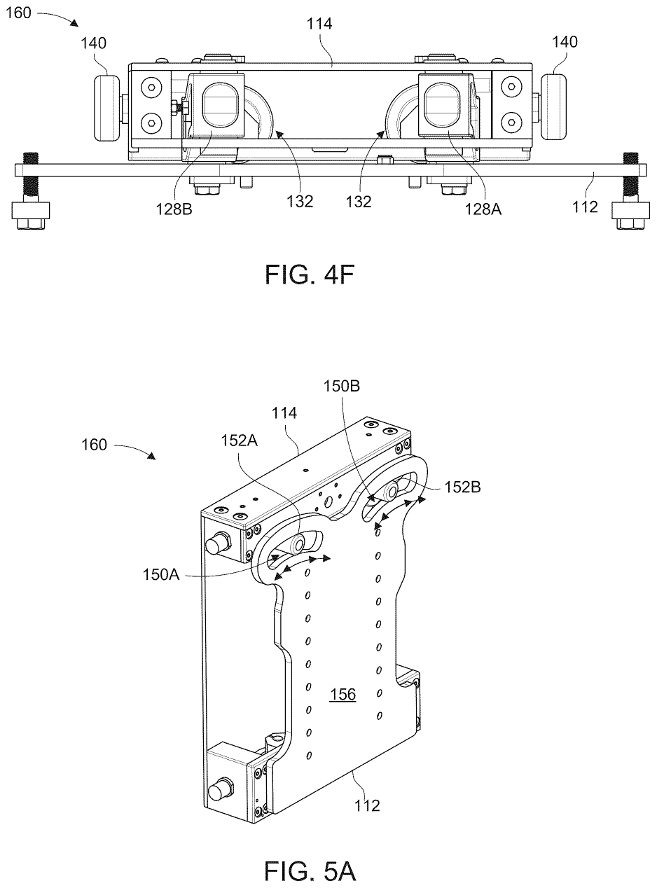

In various embodiments, each pair of wheels 140 may be aligned so as to rotate about a respective common axis 176, as shown in FIG. 4C. In various embodiments, each common axis 176 may be centered along a common axle extending between the pair of wheels 140 and may be mounted on to the wheels 140. In various embodiments, each common axis 176 may be centered along respective separate axles of the pair of wheels 140, the pair of wheels 140 being spaced apart from each other so as to rotate independently on their respective axles. The common axes 176 may be separated by a spacing 174.

Referring to FIGS. 3A-3B, the joint assembly 116 includes a pair of members 128A, 128B. The joint assembly 116 is coupled to the plate 112 via the vertical face 156 of the plate 112. Each of the members 128A, 128B is pivotably coupled to each of the plate 112 and the bracket 114 to allow the plate 112 to swing about the bracket 114. Such swinging, rotational, or rocking motion of the members 128A, 128B causes curvilinear motion 146 or travel of the plate 112 to facilitate horizontal shock absorption. The member 128A is pivotably coupled to the face 156 of the plate 112 at the joint 117A at one end thereof and pivotably coupled to the bracket 114 at another, opposite end thereof. The member 128B is pivotably coupled to the face 156 of the plate 112 at the joint 117B at one end thereof and pivotably coupled to the bracket 114 at another, opposite end thereof. The axes of rotation of the members 128A, 128B at the respective (pivoting) joints 117A, 117B with the plate 112 may be parallel to each other. Such axes of rotation may also be parallel to axes of rotation at (pivoting) joints connecting the members 128A, 128B to the bracket 114. For example, in such an embodiment, the plate 112 may be constrained to planar motion relative to the bracket 114. Such planar motion may be parallel to the vertical plane 142. The bracket 114 may be constrained to vertical motion parallel to the vertical plane 142.

The dampers 118A, 118B move along inclined directions 147 to dampen both horizontal and vertical movement. A such, the dampers 118A, 118B may dampen (horizontal) movement of the plate 112 relative to the bracket 114 while also dampening (vertical) movement of the bracket 114 relative to the base 120 and/or the vessel. As shown in FIG. 3B, the pair of dampers 118A, 118B correspond to the pair of members 128A, 128B.

An anti-friction device 132 is disposed between the plate 112 and the bracket 114. The anti-friction device 132 is independent of the joint assembly 116. The anti-friction device 132 may not form part of the joint assembly 116 and may not form a coupling joint between the plate 112 and the bracket 114. In some embodiments, the anti-friction device 132 may be spaced apart from the joint assembly 116. The anti-friction device 132 supports the plate 112 and the bracket 114 against each other, independent of the joint assembly 116, while allowing the plate 112 and the bracket 114 to move relative to each other. The anti-friction device 132 supports the plate 112 under deformation. The anti-friction device 132 may support the plate 112 and the bracket 114 against each other by contacting each of the plate 112 and the bracket 114 under deformation while allowing the plate 112 and the bracket 114 to move relative to each other.

As referred to herein, an anti-friction device 132 refers to a support structure that is configured to reduce overall frictional resistance to motion by an object, e.g. the plate and/or the bracket, pressed or supported against the anti-friction device 132 to allow sliding thereon. The anti-friction device 132 can reduce friction by means of rollers or by providing a sufficiently rolling or non-rolling smooth frictional surface, e.g. low roughness surface, for the object to slide on. For example, a low roughness height may be desirable to increase smoothness to reduce friction. In some embodiments, the anti-friction device 132 may be a smooth bar or plate. The required reduction in overall frictional resistance to motion may depend on physical characteristics of the object being slid on the anti-friction device 132 and the normal force applied by the object on the anti-friction device 132. For example, greater friction reduction, such as in the form of greater smoothness or lubrication, may be required when the object is rougher and/or applies greater force against the anti-friction device 132. Such friction reduction is important as it mitigates heat generation and prevents fusing of the plate and/or bracket (to the friction device and each other) during relative motion therebetween. For example, a clutch effect, wherein the plate and bracket clutch to one another and/or the anti-friction device 132, may be prevented.

In some embodiments, the anti-friction device 132 may be a plurality of rollers. In some embodiments, the anti-friction device 132 may be a bar, plate, or other unitary or non-unitary structure defining a supporting surface that is sufficiently smooth to allow sliding without fusing or clutching of sliding parts to each other.

In various embodiments, the anti-friction device 132 may include a stationary and/or non-rotating element. In various embodiments, the anti-friction device 132 may include no movable joints, e.g. pivoting or rotating joints, and/or may comprise only a unitary and/or stationary component. In some embodiments, the anti-friction 132 may comprise only one or more low friction sliding elements or assemblies, e.g. an anodized aluminum element suitable to slide on a plastic puck.

As shown in FIGS. 3A-3B, the anti-friction device 132 (e.g. each of the plurality of rollers) is attached to the bracket 114 to self-rotate while anchored to the bracket 114. The anti-friction device 132 may be unattached to the plate 112 while attached to the bracket 114, e.g. the anti-friction device 132 may be only resting on or contacting the plate 112 without being attached, fastened, or otherwise coupled to the plate 112. As the plate 112 and/or the bracket 114 deform under mechanical stress, the anti-friction device 132 resists the deformation to improve rigidity of the assembly while allowing the plate 112 to continue to slide against the bracket 114. The anti-friction device 132 includes a plurality of rotatable cylinders 134 that rotate as the plate 112 undergoes motion relative to the bracket 114. It is understood that, in some embodiments, the anti-friction device 132 (one or more, or each of the plurality of rollers) may be attached to the plate 112 instead of the bracket 114, e.g. a plurality of rollers providing anti-friction function may self-rotate while anchored to the plate 112. The anti-friction device 132 may be unattached to the bracket 114 while attached to the plate 112, e.g. the anti-friction device 132 may be only resting on or contacting the bracket 114 without being attached, fastened, or otherwise coupled to the bracket 114. Each roller providing an anti-friction function may self-rotate about a central axis thereof, e.g. the central axis of a rotatable cylinder 134 may define the rotational axis for self-rotation of the corresponding roller.

As shown in FIGS. 3A-3B, a faceplate 130 may be disposed over the anti-friction device 132. The faceplate 130 may attached, fastened, and/or bolted so as to form part of the bracket 114. The faceplate 130 may define a plurality of slots to allow protrusion therethrough of the anti-friction device 132. For example, each rotatable cylinder 134 may be received through a corresponding slot of the faceplate 130. Advantageously, this may prevent damage to the anti-friction device 132, e.g. by mitigating mispositioning of the plate 112. Advantageously, the faceplate 130 may mitigate failure of the anti-friction device 132 by providing a load-bearing member in the event of excessive forces applied on to the plate 112 and/or the bracket 114.

FIG. 4A is a perspective view of a subassembly 160 of the suspension system 102 of FIGS. 3A-3B.

FIG. 4B is a front elevation view of the subassembly 160 of FIG. 4A.

FIG. 4C is a rear elevation view of the subassembly 160 of FIG. 4A.

FIG. 4D is a side elevation view of the subassembly 160 of FIG. 4A.

FIG. 4E is a bottom plan view of the subassembly 160 of FIG. 4A.

FIG. 4F is a top plan view of the subassembly 160 of FIG. 4A.

The subassembly 160 comprises the plate 112, the bracket 114, the joint assembly 116 coupling the plate 112 to the bracket 114. The curvilinear motion of the plate 112 is indicated by double-headed arrows in FIG. 4B. Notional directions of force applied on the bracket 114 by the plate 112 and an opposing force are indicated by double-headed arrows in FIG. 4E.

The subassembly 160 attaches to other components of the suspension system 102. The seat pan 110 may attach to the plate 112 of the subassembly 160. The bracket 114 of the subassembly may be attached to the base 120, as shown in FIGS. 3A-3B.

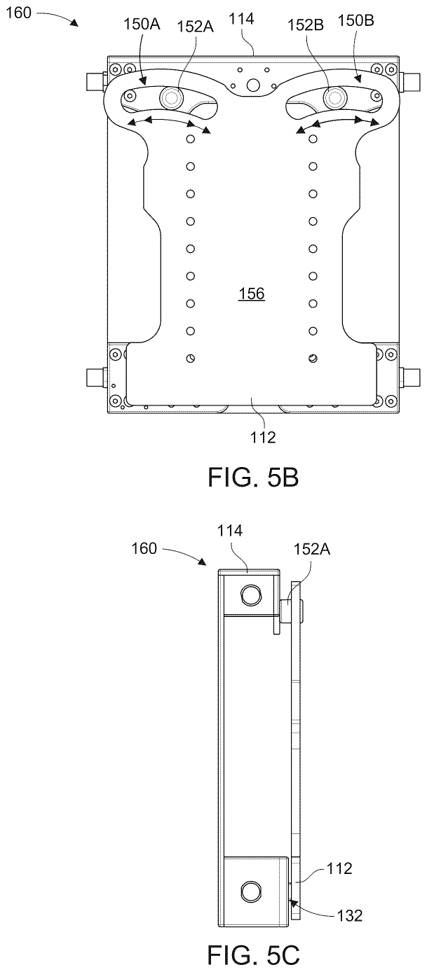

FIG. 5A is a perspective view of a subassembly 160 of the suspension system 102, in accordance with another embodiment.

FIG. 5B is a front elevation view of the subassembly 160 of FIG. 5A.

FIG. 5C is a side elevation view of the subassembly 160 of FIG. 5A.

Referring to FIGS. 5A-5C, the joint assembly 116 comprises a pair of cam slots 150A, 150B and a pair of cam followers 152A, 152B complementary to, and received into, the pair of cam slots 150A, 150B. Each cam slot 150A, 150B may receive a corresponding cam follower 152A, 152B. The cam slots are formed on the vertical face 156 defined by the plate 112 and to which the seat pan 110 is attached. The curvilinear motion of the plate 112 achieved by sliding of the cam followers 152A, 152B in the cam slots 150A, 150B is indicated by double-headed arrows in FIG. 5A.

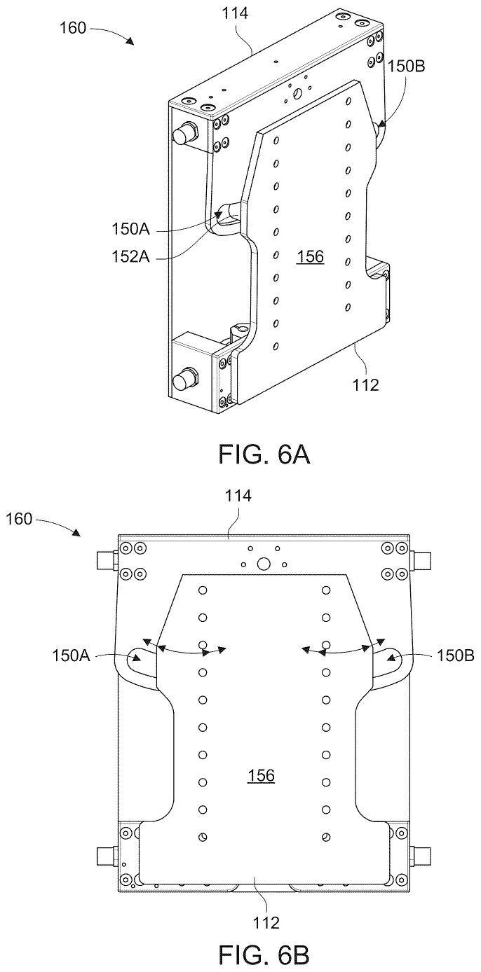

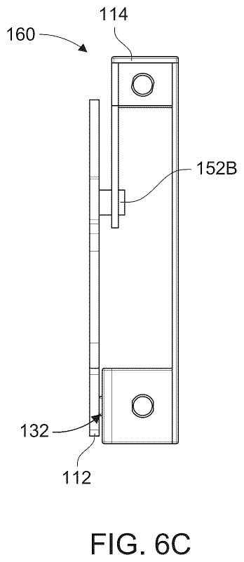

FIG. 6A is a perspective view of a subassembly 160 of the suspension system 102, in accordance with yet another embodiment.

FIG. 6B is a front elevation view of the subassembly 160 of FIG. 6A.

FIG. 6C is a side elevation view of the subassembly 160 of FIG. 6A.

Referring to FIGS. 6A-6C, the joint assembly 116 comprises a pair of cam slots 150A, 150B and a pair of cam followers 152A, 152B complementary to, and received into, the pair of cam slots 150A, 150B. Each cam slot 150A, 150B may receive a corresponding cam follower 152A, 152B. The cam slots are formed on the vertical face 156 defined by the plate 112 and to which the seat pan 110 is attached. The curvilinear motion of the plate 112 achieved by sliding of the cam followers 152A, 152B in the cam slots 150A, 150B is indicated by double-headed arrows in FIG. 6A.

Each of the joint assemblies 116 of FIGS. 5A-5C and FIGS. 6A-6C is configured to constrain the plate 112 to planar motion relative to the bracket 114.

In the embodiment of the subassembly 160 in FIGS. 5A-5C, the cam slots 150A, 150B are formed on the plate 112 and the cam followers 152A, 152B are formed on the bracket 114. In the embodiment of the subassembly 160 in FIGS. 6A-6C, the cam slots 150A, 150B are formed on the bracket 114 and the cam followers 152A, 152B are formed on the plate 112.

Each of the cam slots 150A, 150B may be arc-shaped, e.g. each of the cam slots 150A, 150B may define a centreline or centroid extending therealong that is a circular arc to cause the respective cam followers 152A, 152B to trace an arc in space when they slide along their respective cam slots 150A, 150B. Each of the cam slots 150A, 150B may be substantially identical.

Each of the cam followers 152A, 152B may substantially cylindrical. The diameter of each of the cam followers 152A, 152B is adapted to corresponding widths of the cam slots 150A, 150B, e.g. the diameters may be slightly smaller than the widths. The cam followers 152A, 152B may be slidable and rotatable within their respective cam slots 150A, 150B.

As the cam followers 152A, 152B slide within the cam slots 150A, 150B, the plate 112 slides horizontally relative to the bracket 114 and rotates relative to the bracket 114.

In various embodiments, the cam follower 152A, 152B may include sliders, e.g. linear plain bearing. In various embodiments, the cam slots 150A, 150B may include a rail, e.g. a curved double rail (with square rail profile) suitable to receive a linear plain bearing.

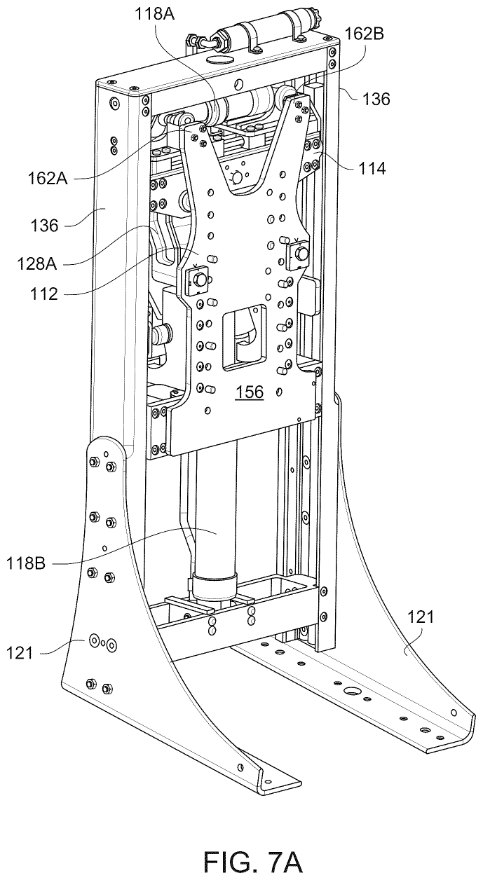

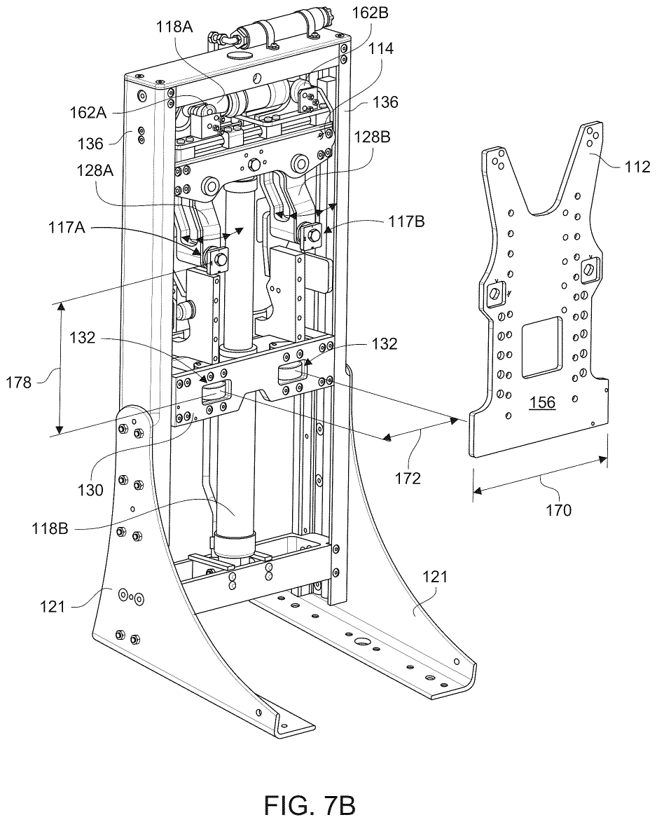

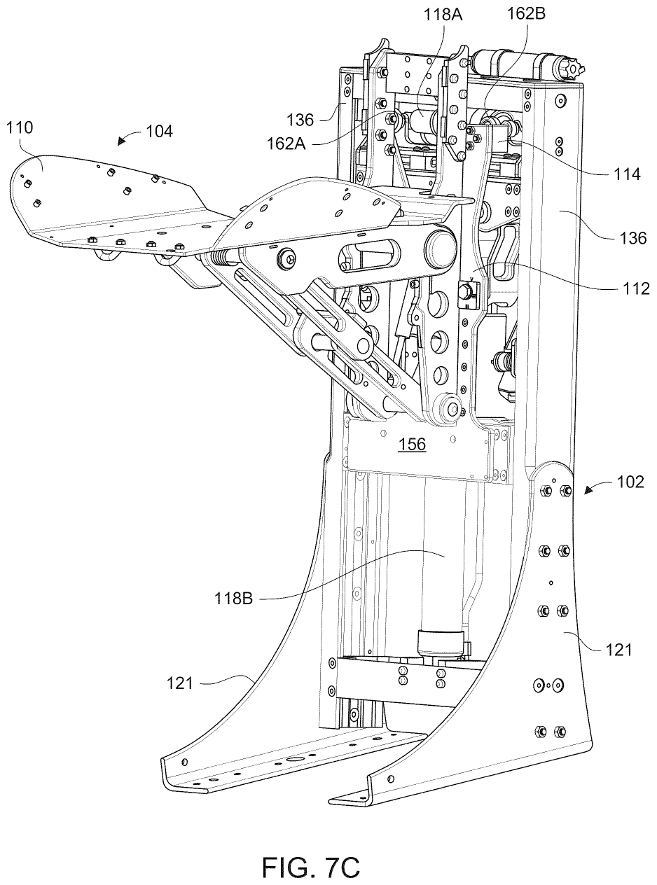

FIG. 7A is a perspective view of a suspension system 102, in accordance with another embodiment.

FIG. 7B is a partially exploded perspective view of the suspension system 102 of FIG. 7A.

FIG. 7C is a perspective view of the suspension system 102 of FIG. 7A having mounted thereon a seat pan 110.

Referring to FIGS. 7A-7C, the suspension system 102 comprises two dampers, a horizontal damper 118A and a vertical damper 118B.

The horizontal damper 118A may be rigidly mounted to the bracket 114 or otherwise mounted on to the suspension system 102 to remain stationary relative to the bracket 114. The horizontal damper 118A may be connected to the plate 112 to damp horizontal, rotating, and/or curvilinear motion thereof relative to the bracket 114.

Referring to FIGS. 7A-7C, the horizontal damper 118A may be pivotably coupled to the plate 112 via a pair of pivot joints 162A, 162B disposed at opposite ends of the horizontal damper 118A such that the horizontal damper 118A provides damping to movement of the pair of pivot joints 162A, 162B to or away from each other. For example, the horizontal damper 118A may be a cylindrical damper such as a twin tube damper and the pair of pivot joints 162A, 162B may be formed at opposite longitudinal ends of the horizontal damper 118A. When the seating system 100 receives a shock, the plate 112 slides sideways and also rotates. Such rotation, and hence horizontal movement, of the plate 112 is damped by the horizontal damper 118A. The damper 118B is connected to the base 120 and the bracket 114 to dampen vertical movement of the bracket 114 relative to the base 120.

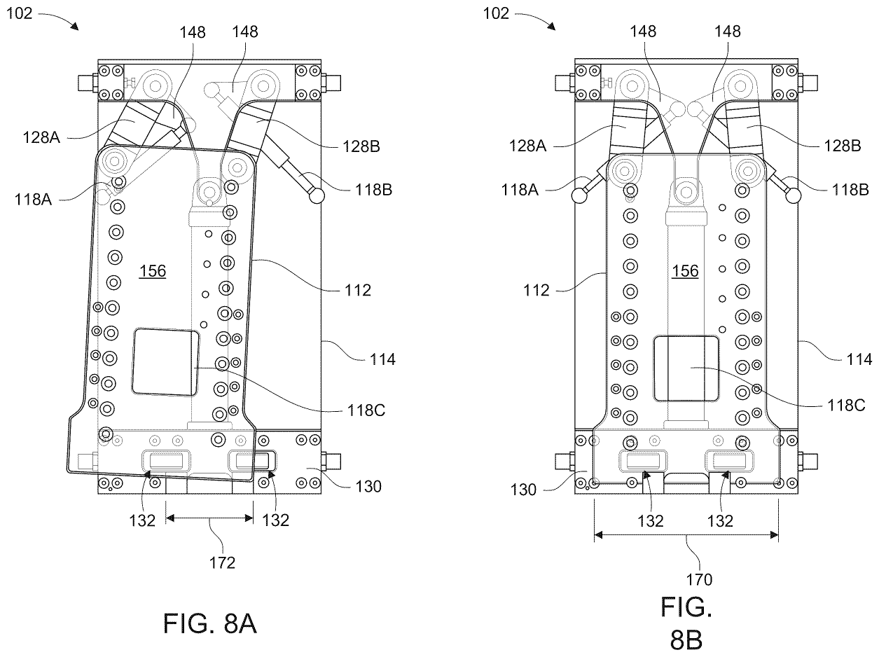

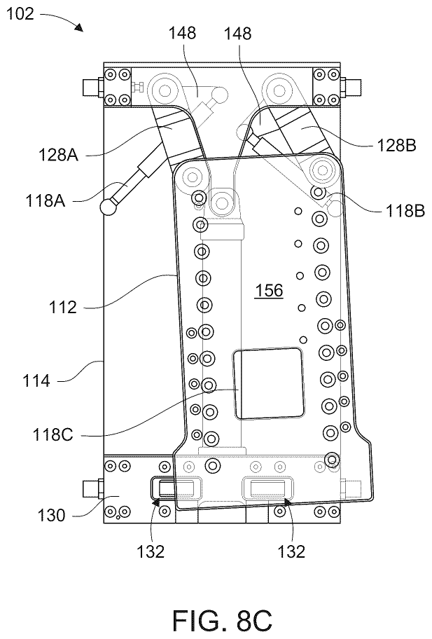

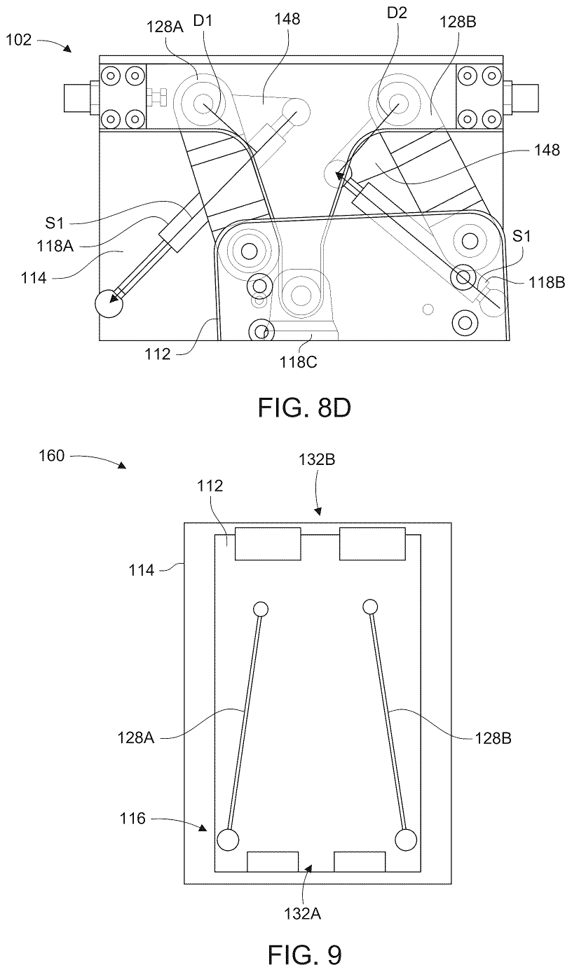

FIG. 8A is a schematic front elevation view of a portion of a suspension system 102 in a first stage of operation, in accordance with an embodiment.

FIG. 8B is a schematic front elevation view of the portion of the suspension system 102 in a second stage of operation, in accordance with an embodiment.

FIG. 8C is a schematic front elevation view of the portion of the suspension system 102 in a third stage of operation, in accordance with an embodiment.

FIG. 8D is an enlarged front elevation view of the portion of the suspension system 102 in FIGS. 8A-8C.

In the drawings in FIGS. 8A-8D, the plate 112 is rendered semi-transparent.

Similar to the embodiments of the suspension system 102 in FIGS. 3A-3B, 4A-4F, 7A-7C, the embodiment of FIGS. 8A-8D includes a pair of members 128A, 128B, each of which is pivotably coupled to each of the plate 112 and the bracket 114.

The suspension system 102 in FIGS. 8A-8D further includes dampers 118A, 118B corresponding to the pair of members 128A, 128B. Additionally, a vertical damper 118C is coupled to the base 120 (not shown) and is provided to dampen vertical movement of the bracket 114. Each of the pair of dampers 118A, 118B is attached to the bracket 114 and is attached to a corresponding member of the pair of members 128A, 128B via a corresponding arm 148 (or link pivot). Each arm 148 extends perpendicularly away from its corresponding member 128A, 128B. In such embodiments, as the plate 112 travels horizontally between two opposing ends (two positions of the plate 112 that define that maximum horizontal movement of the plate 112), the dampers 118A, 118B are successively and alternately extended and compressed. For example, as shown in FIG. 8C, the damper 118A is extended and the damper 118B is compressed.

In some embodiments, the damper 118A, 118B may be gas springs. FIG. 8D shows a preferred embodiment for when the dampers 118A, 118B are gas springs. The members 128A, 128B, dampers 118A, 118B, and the arms 148 are configured such that when the plate 112 is at a peak horizontal travel, a distance D2 between the arm 148 of the member 128B and a force vector S1 of the compressed damper 118B is greater than a distance D1 between the arm 148 of the member 128A and a force vector S2 of the extended damper 118A. Advantageously, such a configuration facilitates helps increasing the force to return the plate 112 back to center and is especially important when using gas springs which may tend to have relatively low force ratios of around 1.4, i.e. a force during maximum compression of a damper may only be 1.4 times higher than a force during maximum extension of the damper. Compared to a linear spring which has a theoretical force ratio of infinity (i.e., zero force at full extension). The difference between distances D1 and D2 may be less important when using dampers that greater force ratios.

FIG. 9 is a schematic front elevation view of a subassembly 160, in accordance with yet another embodiment.

The subassembly 160 of FIG. 9 may be similar in some respects to that shown in FIGS. 4A-4D. However, the subassembly 160 of FIG. 9 may comprise a first anti-friction device 132A (e.g. a first pair of rollers) disposed below the joint assembly 116 and a second anti-friction device 132B (e.g. a second pair of rollers) disposed above the joint assembly 116.

It is found to be advantageous to increase the length of the members 128A, 128B. However, increasing the length of the members 128A, 128B may require additional support to achieve a desired rigidity and reduce mechanical stress on the members 128A, 128B. It is found that using two spaced apart sets of anti-friction devices 132A, 132B may allow the use of longer members 128A, 128B while maintain a required rigidity and strength.

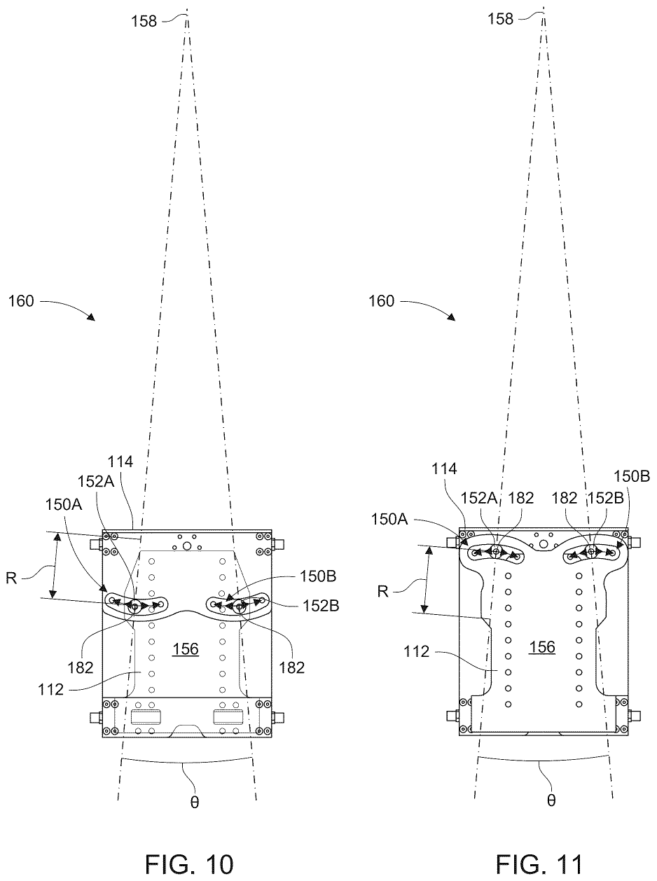

FIG. 10 is a schematic front elevation view of the subassembly 160 of FIGS. 6A-6B. In this drawing, the plate 112 is shown semi-transparent for clarity.

FIG. 11 is a schematic front elevation view of the subassembly 160 of FIGS. 5A-5B.

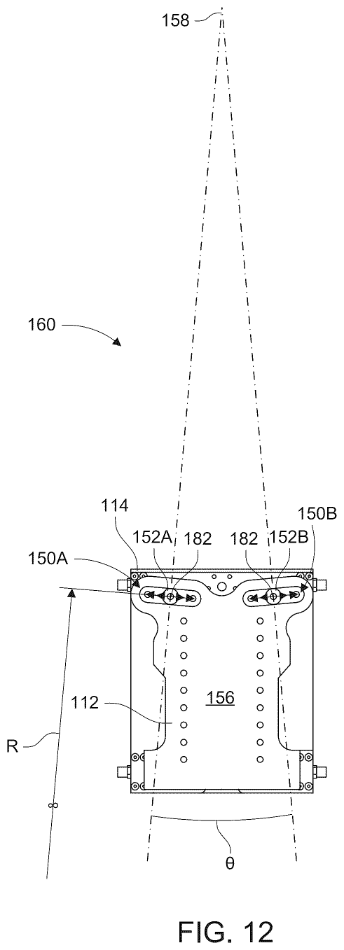

FIG. 12 is a schematic front elevation view of a subassembly 160, in accordance with further yet another embodiment.

FIGS. 10-12 show various embodiments of subassemblies implemented using cam slots 150A, 150B and cam followers 152A, 152B. Advantageously, using cam slots and followers instead of pivotable members allow mimicking extremely long link length to reduce the amount of vertical movement. The instant centers 158 associated with the plate 112 for each of the subassemblies 160 are shown in FIG. 10-12. The instant center height is set by the angle O and other parameters.

As the plate 112 moves, the instant center 158 may change. The set of all the feasible kinematic configurations of the plate 112 relative to the bracket 114 then define a centrode (relative to the bracket 114), i.e. the locus of instant centers 158 of the set of all the feasible kinematic configurations of the plate 112. In various embodiments, the centrode is entirely traced vertically above the joint assembly 116 and the seat pan 110, relative to the bracket 114.

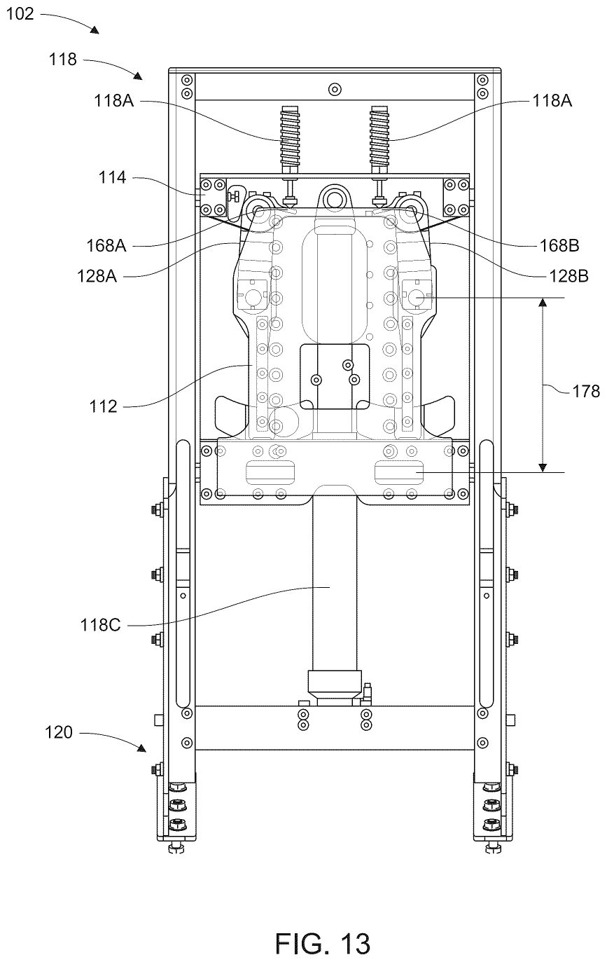

FIG. 13 is a front elevation of a suspension system 102, in accordance with another embodiment.

In the embodiment of FIG. 13, the dampers 118A, 118B are oriented vertically and configured to engage with respective tangs 168A, 168B, which are coupled to the members 128A, 128B. The tangs 168A, 168B push the dampers 118A, 118B to cause engagement of thereof with a frame to cause damping. For example, the dampers 118A, 118B may be springs. A vertical damper 118C is coupled to the bracket 114 and the base 120 to dampen vertical movement thereof.

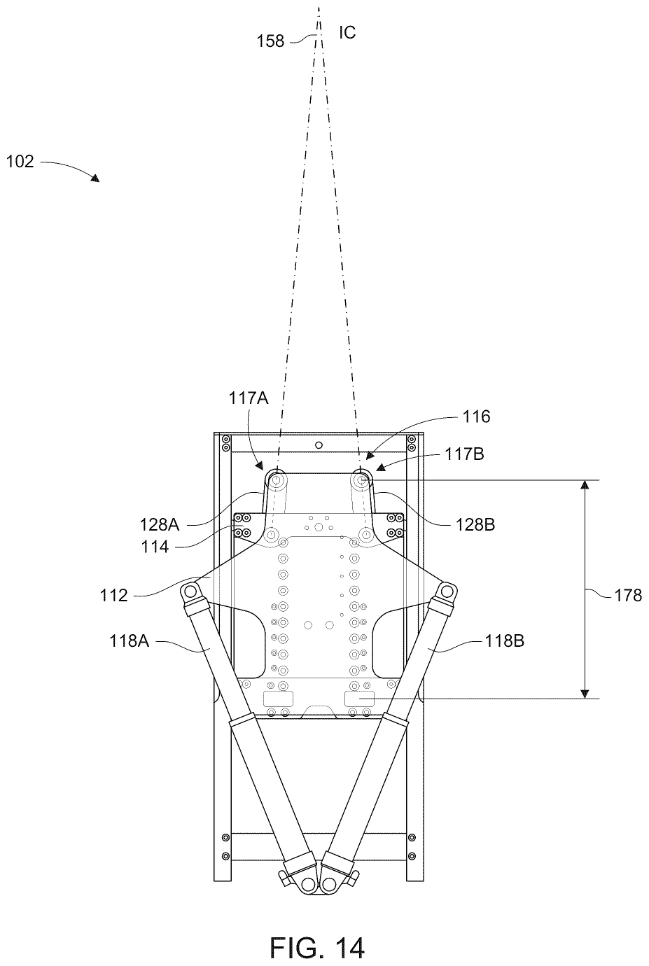

FIG. 14 is a schematic front elevation view of a suspension system 102, in accordance with an embodiment. In the embodiment of FIG. 14, the members 128A, 128B are inverted. In FIG. 14, the plate is shown semi-transparent for clarity.

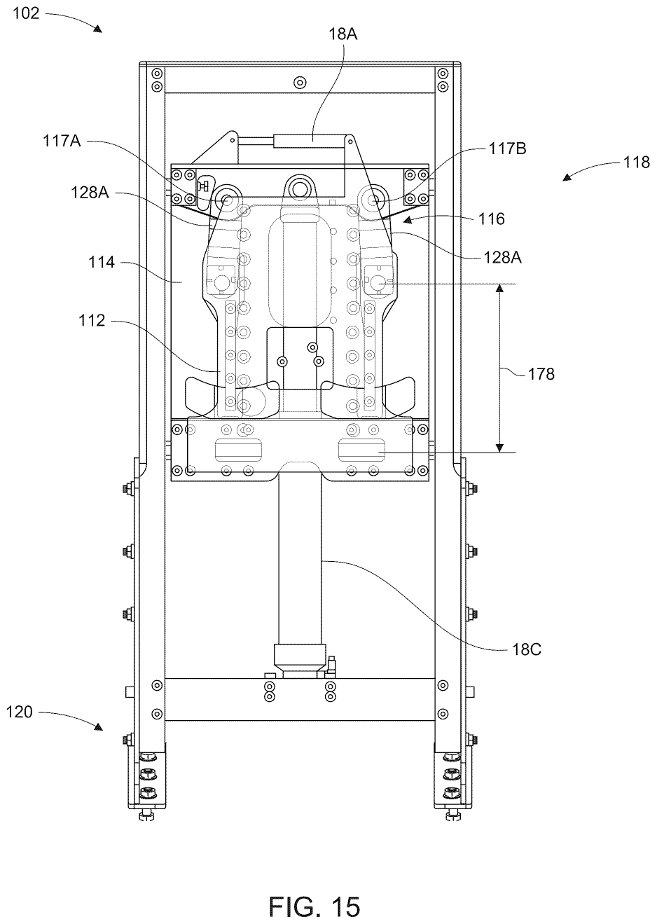

FIG. 15 is a schematic front elevation view of a suspension system 102, in accordance with yet another embodiment. The suspension system 102 includes a damper assembly 118 comprising dampers 118A, 118B. The damper 118A is coupled to the plate 112 and the bracket 114 at opposite ends thereof. The damper 118A is configured such that the plate 112 and the bracket 114 are aligned and centered with respect to each other when the damper 118A is in a resting or relaxed position. The damper 118C is coupled to the bracket 114 and the base 120 to dampen vertical movement of the bracket 114. Advantageously, the plate 112 and the bracket 114 in FIG. 15 is self-centering.

The seating system 100 may be installed on a vessel 10 such as a high-speed boat by bolting or otherwise fastening the bracket 114, or base 120, on to the vessel 10. Once fastened a user may seat themselves on the seat pan 110. Once securably seated, the vessel 10 may begin moving at high speeds through the water. Such movement creates sudden movements (shocks) that are transmitted through the vessel 10 to the seating system 100. In response to a general forcing or shock, the bracket 114 may translate vertically to compensate for a vertical component of the shock, with dampers absorbing energy as the seat pan 110 rises and falls, and the plate 112 may translate horizontally (or in a vertical-horizontal plane) to compensate for a horizontal component of the shock, with dampers again absorbing energy as the seat pan 110 rocks sideways. While such translation is taking place, the anti-friction device 132 is engaged between the plate 112 and the bracket 114, and self-rotate to accommodate movement of the plate 112 against the bracket 114. The plate 112 and the bracket 114 continue to push against each other via the anti-friction device 132, which in turn maintain rigidity of the assembly and mitigate excessive deformation while avoiding any significant interference with the shocking mitigation and absorption functions of the seating system 100. Multi-di mensional shock mitigation is thereby achieved.

In various embodiments, the plate 112 may be dimensioned to allow the anti-friction device 132 (e.g. a support or rollers) to support the plate 112 as it moves horizontally. For example, a width 170 of the bottom of the plate 112 may be dimensioned so that the anti-friction device 132 remains in contact with the plate 112 through reciprocal motion of the plate 112 relative to the bracket 114, or vice versa. In various embodiments, the width 170 may be at least 1.5 times the distance between opposite ends of the anti-friction device 132. In some embodiments, the width 170 may be at least 1.5 times the center-to-center distance 172 between rollers of the anti-friction device 132. Advantageously, increasing spacing between the rollers may improve stability of the plate 112.

In various embodiments, it is found advantageous to increase a vertical distance 178 between the anti-friction device 132 and each of the pivoting joints 117A, 117B. In various embodiments, the distance between the anti-friction device 132 and each of the pivoting joints 117A, 117B may vary during reciprocal motion of the plate 112 relative to the bracket 114, and vice versa. As defined here, the vertical distance 178 may refer to a maximum vertical distance, minimum vertical distance, average vertical distance, and/or a resting or neutral vertical distance (e.g. vertical distance when the plate 112 and the bracket 114 are stably resting relative to each other). For example, in some embodiments, an increased vertical distance 178 may reduce applied loading or stress on each of the members 128A, 128B and the anti-friction device 132 due to cantilevered seat and/or occupant mass. For example, it may be particularly advantageous to utilize inverted members 128A, 128B as they may facilitate significantly increasing vertical distance 178 between the anti-friction device 132 and the pivoting joints 117A, 117B. An example embodiment utilizing inverted members 128A, 128B is illustrated in FIG. 14.

In various embodiments, it is found that increasing the spacing 174 between the common axes 176 (and the pairs of wheels 140) may advantageously reduce the load on axles of the wheels 140 caused by the cantilevered seat and/or occupant mass. The spacing 174 may be based on at least a required vertical travel of the plate 112 relative to the bracket 114, and/or on an allowable size of the subassembly 160.

In various embodiments, the anti-friction device 132 may be aligned with a pair of the wheels 140, e.g. a lower pair of wheels 140. For example, the anti-friction device 132 may be centered along the common axis 176 of a pair of wheels 140 or vertically centered on this common axis 176. Advantageously, such alignment may mitigate formation of bending moments due to vertical spacing between the common axis 176 and the anti-friction device 132 to thereby reduce deformation during operation.

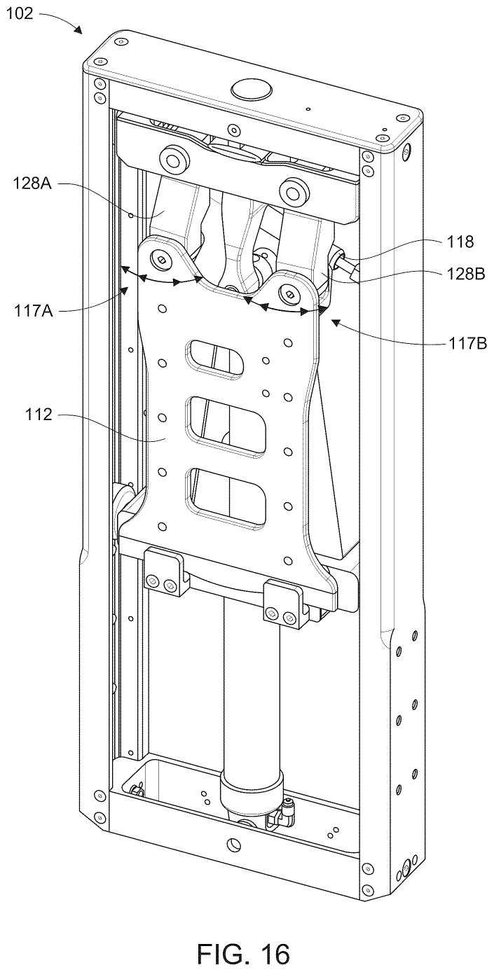

FIG. 16 is a perspective view of a seating system 102, in accordance with an embodiment.

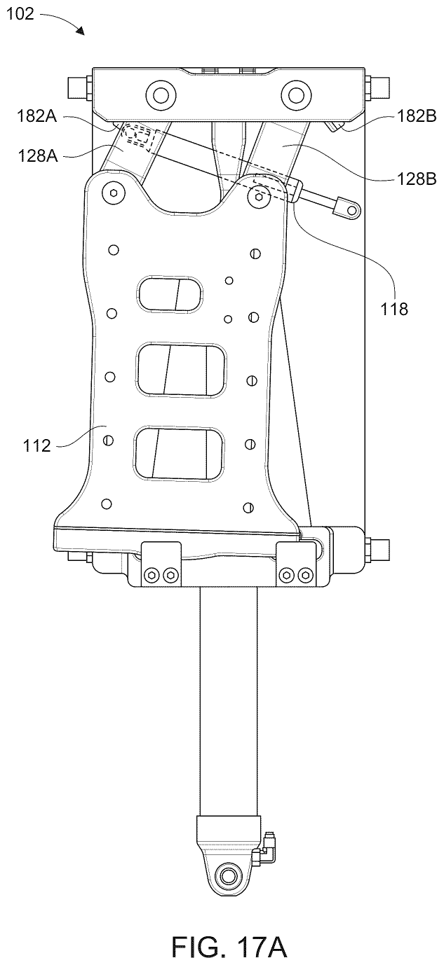

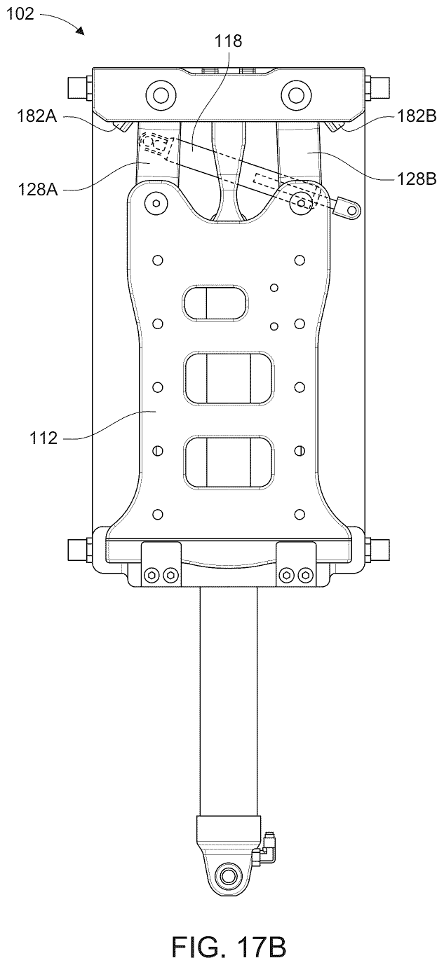

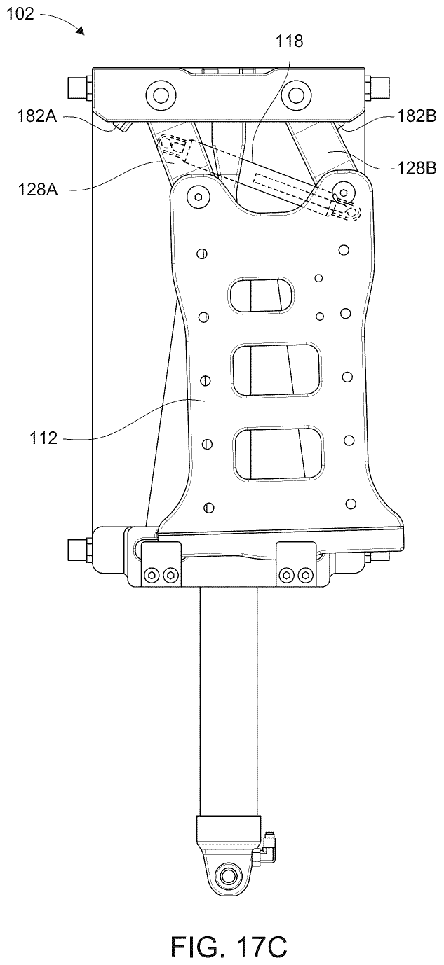

FIG. 17A is a front elevation view of a subassembly of the seating system 102 of FIG. 16 in a first position.

FIG. 17B is a front elevation view of a subassembly of the seating system 102 of FIG. 16 in a second position.

FIG. 17C is a front elevation view of a subassembly of the seating system 102 of FIG. 16 in a third position.

In the first position, the plate 112 is in a rightmost position. In the second position, the plate 112 is centred. In the third position, the plate 112 is in a leftmost position.

Referring to FIGS. 16, 17A-17C, the seating system 102 comprises a damper assembly 118 and members 128A, 128B. The damper assembly 118 includes one and only one damper. The single damper is mounted to one member 128A and one member 128A alone. In particular, a first (terminal) end of the single damper is attached to the member 128A and a second opposite (terminal) end of the single damper is attached to a stationary portion of the seating system 102. The single damper may be a pure damper and may not provide a spring force. Advantageously, the arc of the members 128A, 128B may provide sufficient “self-centering” force such that an external spring may not be required.

The seating system 102 may comprise bumpers 182A, 182B or bottom-out bumpers to allow seat member(s) 128A, 128B and/or the single damper to abut to limit travel or motion thereof as the plate 112 swings between the first, second, and third positions.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, no back rest may be provided, the seat pan may itself have integrated therewith a back rest, and the suspension systems described here may be configured for only horizontal movement and/or damping without vertical travel permitted by removing dampers and assemblies provided to enable vertical movement and/or damping. Yet further modifications could be implemented by a person of ordinary skill in the art in view of the present disclosure, which modifications would be within the scope of the present technology.

1. A seating system for a vessel, comprising:
a seat pan;
a plate coupled to the seat pan to support the seat pan;
a bracket anchored to the vessel;
a joint assembly coupling the plate to the bracket to constrain the plate to reciprocal curvilinear motion relative to the bracket to allow confined horizontal movement of the seat pan relative to the bracket for shock mitigation;
a damper assembly oriented to dampen movement of the plate relative to the bracket to absorb horizontal shocks; and
an anti-friction device disposed between the plate and the bracket to support the plate and the bracket against each other, independent of the joint assembly, while allowing the plate and the bracket to move relative to each other.

2. The seating system of claim 1, wherein the anti-friction device is spaced apart from the joint assembly.

3. The seating system of claim 1, wherein the anti-friction device includes a plurality of rollers.

4. The seating system of claim 3, wherein each of the plurality of rollers is attached to the bracket to self-rotate while anchored to the bracket.

5. The seating system of claim 3, wherein the plurality of rollers include a plurality of rotatable cylinders.

6. The seating system of claim 1, wherein the joint assembly comprises a pair of cam slots and a pair of cam followers complementary to, and received into, the pair of cam slots.

7. The seating system of claim 6, wherein the plate defines a vertical face on which the cam slots are formed and to which the seat pan is attached.

8. The seating system of claim 1, wherein the joint assembly includes a pair of members, each of the members pivotably coupled to each of the plate and the bracket to allow the plate to swing about the bracket for shock mitigation.

9. The seating system of claim 8, wherein the damper assembly includes a pair of dampers corresponding to the pair of members.

10. The seating system of claim 8, wherein each damper of the pair of dampers is attached to the bracket and is attached to a corresponding member of the pair of members via a corresponding arm extending perpendicularly away from the corresponding member.

11. The seating system of claim 1, wherein the joint assembly is configured to constrain the plate to planar motion relative to the bracket.

12. The seating system of claim 1, wherein all feasible kinematic configurations of the plate relative to the bracket define a centrode entirely traced vertically above the joint assembly and the seat pan.

13. The seating system of claim 1, wherein the damper assembly includes a pair of dampers inclined in opposing directions in a vertical plane to allow damping of horizontal movement of the plate relative to the bracket and vertical movement of the bracket relative to the vessel.

14. The seating system of claim 13, further comprising:
a base rigidly attached to the vessel, the bracket being slidably coupled to the base to allow constrained vertical sliding of the bracket relative to the base, the pair of dampers coupled to the base to allow damping of the constrained vertical sliding of the bracket relative to the base.

15. The seating system of claim 1, further comprising:
a base attached to the vessel, the bracket being slidably coupled to the base to allow constrained vertical sliding of the bracket relative to the base, wherein a damper is connected to the base and the bracket to dampen vertical movement of the bracket relative to the base.

16. The seating system of claim 1, wherein the plate defines a vertical face to which is attached the seat pan, the seating system further comprising:
a platform positioned below the seat pan and cantilevered perpendicularly outwardly from the plate to support the seat pan; and
a brace disposed between the plate and the platform and inclined relative to the plate to couple the plate to the platform to support the platform.

17. The seating system of claim 16, further comprising:
an inclined damper coupled to the platform and the plate to dampen movement of the brace.

18. The seating system of claim 17, wherein the brace is a two-bar linkage.

19. The seating system of claim 1, wherein the anti-friction device is a first anti-friction device and is disposed below the joint assembly, the seating system further comprising:
a second anti-friction device disposed between the plate and the bracket to support the plate and the bracket against each other, independent of the joint assembly, while allowing the plate and the bracket to move relative to each other, the second anti-friction device being positioned above the joint assembly.

20. The seating system of claim 19, wherein the second anti-friction device is spaced apart from the joint assembly.

21. A marine vessel, comprising a seating system according to claim 1, wherein the vessel is the marine vessel.

22. A suspension system for a seat pan of a vessel, comprising
a plate suitable to be coupled to the seat pan to support the seat pan;
a bracket anchored suitable to be anchored to the vessel;
a joint assembly coupling the plate to the bracket to constrain the plate to reciprocal curvilinear motion relative to the bracket to allow confined horizontal movement of the seat pan relative to the bracket for shock mitigation;
a damper assembly oriented to dampen movement of the plate relative to the bracket to absorb horizontal shocks; and
an anti-friction device disposed between the plate and the bracket to support the plate and the bracket against each other, independent of the joint assembly, while allowing the plate and the bracket to move relative to each other.

23. The suspension system of claim 22, wherein all feasible kinematic configurations of the plate relative to the bracket define a centrode entirely traced vertically above the joint assembly.

24. The suspension system of claim 22, further comprising:
a base suitable to be attached to the vessel, the bracket being slidably coupled to the base to allow constrained vertical sliding of the bracket relative to the base, wherein a damper is connected to the base and the bracket to dampen vertical movement of the bracket relative to the base.

25-47. (canceled)
